(19) United States
(12) Patent Application Publication
(10) Pub. No.: US 2002/0077998 A1
(43) Pub. Date: Jun. 20, 2002

(54) Web based system and method for managing sales deals

(76) Inventors: Brian Andrews, Acworth, GA (US); Bina Cline, Atlanta, GA (US); Gregg Haddad, Marietta, GA (US)

Correspondence Address: John S. Beulick, Esq., Armstrong Teasdale LLP, Suite 2600, One Metropolitan Sq., St. Louis, MO, 63102, US

(21) Appl. No.: 09/732,589

(22) Filed: Dec. 8, 2000

(51) Int. Cl. G06F 7/00

(52) U.S. Cl. 707/1

(57) ABSTRACT

A Sales Lead/Deal Management System utilizes a web-enabled interactive database to automate the process for assigning and unassigning deals, managing deals, and tracking/reporting status of the deals as necessary to effectively manage the business. The system captures all deals related information including contact details, disposition and provides on-line up-to-date information upon request.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to management of sales leads, also referred to as deals, and more particularly, to network-based systems and methods for tracking sales leads using an interactive database.

In a business entity, documentation relating to sales leads and follow-ups are typically maintained through a combination of hard-copy files separately maintained by individual sales managers within a sales department. Sales leads typically are tracked by paper, faxes, and e-mails that may be hard to find and easily lost. Sales managers assign the leads to their sales representatives through a manual process. Subsequent to the assignment, the sales representatives make sales calls, schedule appointments and close the sales, using the manual system. Sales representatives are typically tasked with tracking the lead and reporting the disposition to their management. Notifications of successful completion and closing of the sales leads to the management are generally made by personal contact or through internal memorandums.

Individual sales managers maintain the associated records by tracking the sales performance of the business entity in the absence of a centralized management system to track and evaluate the overall compliance with corporate sales, advertising and marketing strategy. Reports of sales lead status including the effectiveness in relation to the overall corporate strategy are generated manually through review of the individual sales success records. The manual system does not provide continuity due to management changes and may result in inaccurate records. The discontinuity and inaccurate records may be problematic for a business entity which is expected to perform profitably under substantial competitive pressures.

### BRIEF SUMMARY OF THE INVENTION

In an exemplary embodiment, a searchable web-based system collects, tracks and disseminates real time information, regarding sales leads and the status of such leads. In another exemplary embodiment of the invention, a web-based method is utilized to track leads using a server system coupled to a centralized interactive database and at least one client system. The method includes receiving lead information, entering the lead information into a centralized database, storing the lead information into the centralized database, cross-referencing the lead information against a unique identifier, and providing the stored lead information in response to a user inquiry.

A Sales Lead Management System (SLMS), in one embodiment, includes a web-enabled interactive database to automate a process for sales leads tracking and management. The SLMS captures all sales lead information and provides on-line, up-to-date information upon request. The SLMS tracks deals from inception to completion and provides a status of these deals to users. Deals are often referred to as sales leads or simply as leads. In the exemplary embodiment, the system utilizes a Relational Database with a client user interface front-end for administration and a web interface for standard user input and reports. Information is accessed in the database through Structured Query Language (SQL). The SLMS includes a sales lead database for use in automating documentation, monitoring and tracking activities associated with management of sales leads.

In an alternative embodiment, the SLMS is integrated with a teleservices outbound call center where leads are pre-qualified by outbound sales representatives and made available via the Internet. Leads are assigned and reassigned by an immediate manager depending on circumstances. In one embodiment, the immediate supervisor is a sales manager. For example, if a sales representative quits his or her organization, his or her leads can be reassigned to another sales representative.

The SLMS supports various levels of management hierarchy and provides access to individuals based on the position held by the individual within the business entity. The SLMS builds a sales funnel from first contact to follow-up to disposition. Leads can be tracked from Qualified, Proposed, Contract, Sale or Loss including reason codes. The SLMS has capability to download data extracted to populate commercialized database programs or spread sheet software, which provides the end-user with additional flexibility. Similarly, the data extracted can be uploaded to the SLMS from commercialized database programs or spread sheet software. A robust notes section allows a historic overview of the lead which can be reviewed by higher level managers or representatives responsible for an account or specific lead.

The SLMS provides a formalized process to track and manage the sales leads. The SLMS also provides a cost benefit by streamlining the management process associated with sales management to improve accountability and performance.

### BRIEF DESCRIPTION OF THE DRAWINGS

FIG. 1 is a simplified block diagram of a Sales Lead Management System (SLMS) in accordance with one embodiment of the present invention;

FIG. 2 is an expanded version block diagram of an exemplary embodiment of a server architecture of the SLMS;

FIG. 3 shows a configuration of a database within the database server of the server system with other related server components;

FIG. 4 is an exemplary embodiment of a first user interface requesting the information about a user or a primary contact person within the organization;

FIG. 5 is an exemplary embodiment of a second user interface downloaded and displayed by the server system when the user selects a continue button (shown in FIG. 4);

FIG. 6 is an exemplary embodiment of a third user interface downloaded and displayed by the server system when the user selects a continue button (shown in FIG. 5);

FIG. 7 is an exemplary embodiment of a fourth user interface downloaded and displayed by the server system when the user selects a continue button (shown in FIG. 6);

FIG. 8 is an exemplary embodiment of a fifth user interface downloaded and displayed by the server system when the user selects a continue button (shown in FIG. 7);

FIG. 9 is an exemplary embodiment of a sixth user interface downloaded and displayed by the server system when the user selects a continue button (shown in FIG. 8);

FIG. 10 is an exemplary embodiment of a seventh user interface downloaded and displayed by the server system when the user has completed the enrollment process;

FIG. 11 is an exemplary embodiment of a user interface depicting sales tracker organization set up screen;

FIG. 12 is an exemplary embodiment of a user interface prompting the user to supply information on level 2 and level 3 territories;

FIG. 13 is an exemplary embodiment of a user interface for providing detail information about every user using the SLMS;

FIG. 14 is an exemplary embodiment of a user interface detailing the organization structure as entered by the user;

FIG. 15 is an exemplary embodiment of a user interface displaying a thank you message once the enrollment is complete informing the user that the enrollment is complete and that the user may now use the system to track sales leads;

FIG. 16 is an exemplary embodiment of a user interface, also known as a home page of the SLMS shown in FIG. 2;

FIG. 17 is an alternative exemplary embodiment of the home page user interface of the SLMS shown in FIG. 2;

FIG. 18 is an exemplary embodiment of a “View Database” user interface providing the user with an ability to perform several functions pertaining to the user's own database maintained within the database;

FIG. 19 is an exemplary embodiment of an “Add New Contact” user interface providing the user with an ability to add new contacts into the database;

FIG. 20 is an exemplary embodiment of a “View Product table” user interface providing the user with an ability to view various products from the database;

FIG. 21 is an exemplary embodiment of an “Import Contact Data” user interface providing the user with an ability to import contacts data from the database;

FIG. 22 is an exemplary embodiment of an “Archive Contacts” user interface providing the user with an ability to archive contacts data to the database;

FIG. 23 is an exemplary embodiment of an “Query Contact Database” user interface providing the user with an ability to query contacts data from the database;

FIG. 24 is an exemplary embodiment of a “View Notes” user interface providing the user with an ability to view various notes stored in the database;

FIG. 25 is an exemplary embodiment of an “Add Notes” user interface providing the user with an ability to add notes to the database;

FIG. 26 is an exemplary embodiment of a “View Action Items” user interface providing the user with an ability to View Action Items stored in the database;

FIG. 27 is an exemplary embodiment of an “Add Action Items” user interface providing the user with an ability to Add Action Items to the database;

FIG. 28 is an exemplary embodiment of a “View Products” user interface providing the user with an ability to view products from the database;

FIG. 29 is an exemplary embodiment of an “Add Products” user interface providing the user with an ability to add products against a specific contact into the database;

FIG. 30 is an exemplary embodiment of a “View Deal Status” user interface providing the user with an ability to view deal status against a specific contact into the database;

FIG. 31 is an exemplary embodiment of a “Change Deal Status” user interface providing the user with an ability to change deal status from one stage to another;

FIG. 32 is an exemplary embodiment of an “Add New Contact” user interface providing the user with an ability to view add new contact against a specific deal into the database;

FIG. 33 is an exemplary embodiment of an “Action Items” user interface providing the user with an ability to view an aggregate list of all actions for all contacts that have not been archived;

FIG. 34 is an exemplary embodiment of a “Reporting” user interface providing the user with an ability to view various reports;

FIG. 35 is an exemplary embodiment of a Contacts Report;

FIG. 36 is an exemplary embodiment of an Action Items Report;

FIG. 37 is an exemplary embodiment of a Sales Funnel Report;

FIG. 38 is an exemplary embodiment of a Sales Forecast Report;

FIG. 39 is an exemplary embodiment of a Won & Lost Deals Report;

FIG. 40 is an exemplary embodiment of a Products Report;

FIG. 41 is an exemplary embodiment of an Export Contacts Report;

FIG. 42 is an exemplary embodiment of an “Add/Update Users” user interface providing the user with an ability to perform several management functions based on the information stored in the database;

FIG. 43 is an exemplary embodiment of a “Change Company Profile” user interface providing the user with an ability to change a company profile stored in the database;

FIG. 44 is an exemplary embodiment of a “Change Payment Information” user interface providing the user with an ability to change payment information stored in the database;

FIG. 45 is an exemplary embodiment of a “Change Organization” user interface providing the user with an ability to change organizational information stored in the database;

FIG. 46 is an exemplary embodiment of an “Add Territory” user interface;

FIG. 47 is an exemplary embodiment of a “Move Territory” user interface;

FIG. 48 is an exemplary embodiment of a “Rename Territory” user interface;

FIG. 49 is an exemplary embodiment of a “Delete Territory” user interface;

FIG. 50 is an exemplary embodiment of a “Change Administrator” user interface providing the user with an ability to change administrator information stored in the database;

FIG. 51 is an exemplary embodiment of an “Add/Update Product Table” user interface providing the user with an ability to Add/Update Product Table information stored in the database;

FIG. 52 is an exemplary embodiment of a “Contacts US” user interface;

FIG. 53 is an exemplary embodiment of a “Frequently Asked Questions” user interface;

FIG. 54 is an exemplary embodiment of a “Pricing” user interface;

FIG. 55 is an exemplary embodiment of a “Terms of Use” user interface; and

FIG. 56 is an algorithm used by the system to help the user practice the SLMS when the user logs on to a home page of the web site through the client system.

### DETAILED DESCRIPTION OF THE INVENTION

Exemplary embodiments of systems and processes that facilitate integrated network-based electronic reporting and workflow process management related to Sales Lead Management System (SLMS) are described below in detail. The SLMS tracks deals from inception to completion and provides a status of these deals to users. Deals are often referred to as sales leads or simply as leads. The systems and processes facilitate, for example, electronic submission of information using a client system, automated extraction of information, and web-based assessment reporting and management of sales leads for users.

The systems and processes are not limited to the specific embodiments described herein. In addition, components of each system and each process can be practiced independent and separate from other components and processes described herein. Each component and process also can be used in combination with other components and processes.

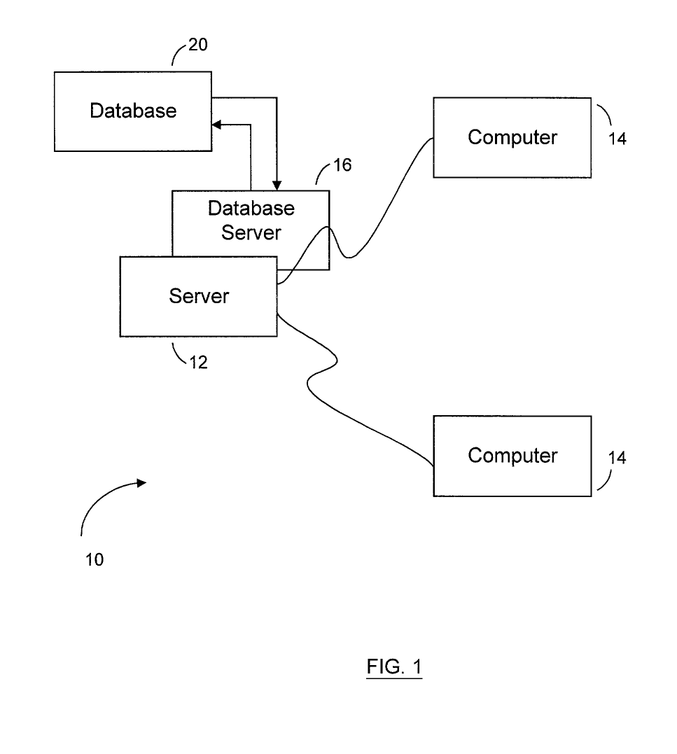

FIG. 1 is a simplified block diagram of a Sales Lead Management System (SLMS) 10 including a server system 12 and a plurality of client systems 14 connected to server system 12. SLMS 10 tracks deals from inception to completion and provides a status of these deals to users. Deals are often referred to as sales leads or simply as leads. In one embodiment, client systems 14 are computers including a web browser, such that server system 12 is accessible to client systems 14 via the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone or other web-based connectable equipment. A database server 16 is connected to a centralized database 20 containing product related information on a variety of products, as described below in greater detail. In one embodiment, centralized database 20 is stored on database server 16 and can be accessed by potential users at one of client systems 14 by logging onto server system 12 through one of client systems 14. In an alternative embodiment centralized database 20 is stored remotely from server system 12.

The SLMS utilizes a web-enabled interactive database to automate a sales leads tracking and management process. System 10 captures all sales lead information and provides on-line, up-to-date information upon request. In one exemplary embodiment, system 10 utilizes a Relational Database with a client user interface front-end for administration and a web interface for standard user input and reports. Information is accessed in the database through Structured Query Language (SQL). The SLMS is a sales lead tracking and management tool that can be used as a stand alone single user, a corporate user with varying levels of sales managers and sales representatives or tightly integrated with a teleservices outbound call center where leads are pre-qualified by outbound sales representatives and made immediately available via the Internet. Leads are assigned and reassigned by an immediate manager or a system's administrator depending on circumstances. For example, if a sales representative quits his or her organization, his or her leads can be reassigned to another sales representative.

System 10 supports various levels of management hierarchy and provides access to individuals based on the position held by the individual within the business entity. System 10 builds a sales funnel from first contact to follow-up to disposition. System 10 facilitates tracking of leads from Qualified, Proposed, Contract, Sale or Loss including reason codes. System 10 is capable of downloading data extracted to populate additional software tools such as Microsoft Excel or Microsoft Access allowing the end-user with additional flexibility. Similarly, the data extracted can be uploaded to the SLMS from products such as Microsoft Excel or Microsoft Access. It may be necessary for the user to convert the file the user wish to upload to a text file prior to importing the file. A robust notes section allows a historic overview of the lead which can be reviewed by higher level managers or representatives taking over an account or specific lead.

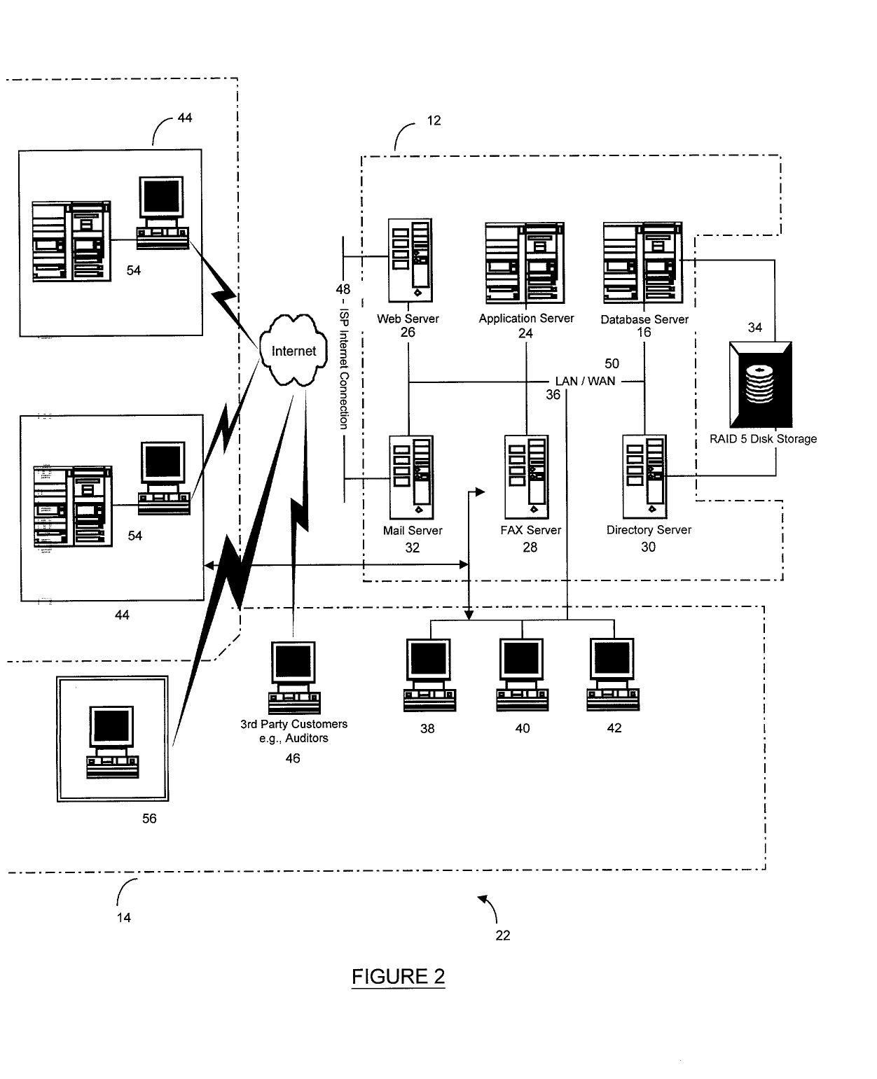

FIG. 2 is an expanded version block diagram of an exemplary embodiment of a server architecture of a Sales Lead Management System (SLMS) 22. Components in system 22, identical to components of system 10 (shown in FIG. 1), are identified in FIG. 2 using the same reference numerals used in FIG. 1. System 22 includes server system 12 and client systems 14. Server system 12 further includes a database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 via an Internet link or are connected through an intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

In another embodiment, server system 12 is configured to be communicatively coupled to various individuals or employees 44 and to third parties, e.g., internal or external auditors, 46 via an ISP Internet connection 48. The communication in the exemplary embodiment is illustrated as being performed via the Internet, however, any other wide area network (WAN) type communication can be utilized in other embodiments, i.e., the systems and processes are not limited to being practiced via the Internet. In addition, and rather than WAN 50, local area network 36 could be used in place of WAN 50.

In the exemplary embodiment, any authorized individual or an employee of the business entity having a workstation 54 can access SLMS 22. One of the client systems includes a senior manager's workstation 56 located at a remote location. Workstations 54 and 56 are personal computers having a web browser. Also, workstations 54 and 56 are configured to communicate with server system 12. Furthermore, fax server 28 communicates with employees located outside the business entity's 44 and any of the remotely located client systems, including a client system 56 via a telephone link. Fax server 28 is configured to communicate with other client systems 38, 40, and 42 as well.

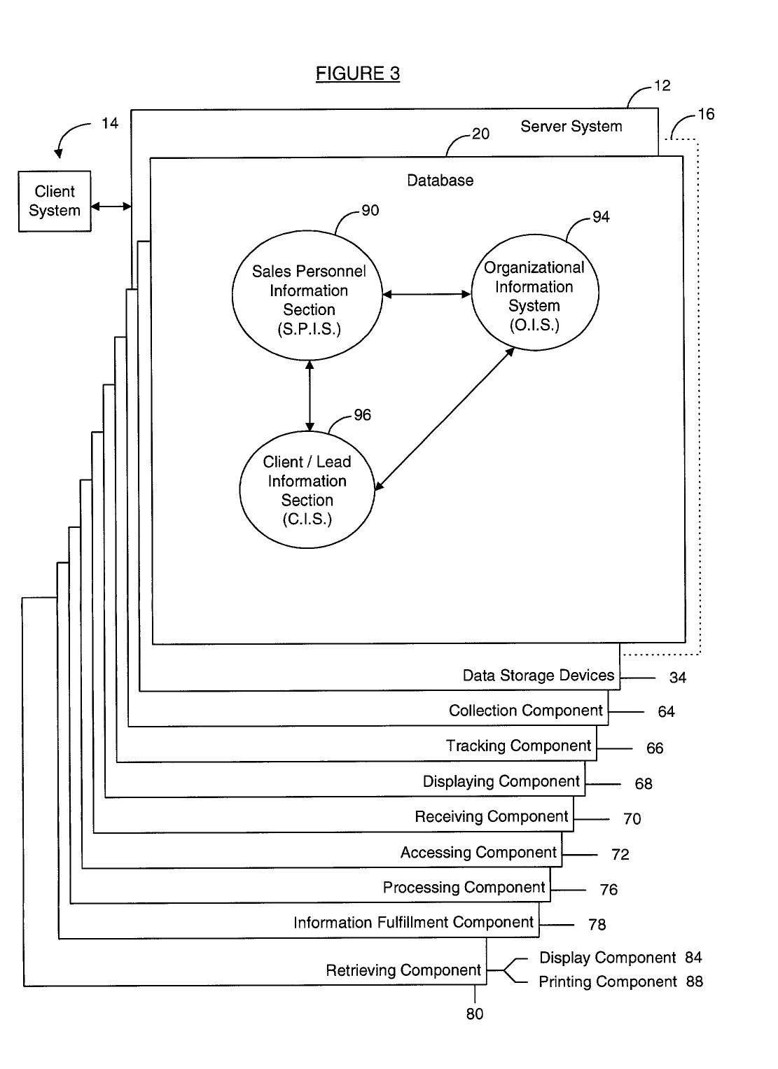

FIG. 3 shows a configuration of database 20 within database server 16 of server system 12 shown in FIG. 1. Database 20 is coupled to several separate components within server system 12, which perform specific tasks.

Server system 12 includes a collection component 64 for collecting information from users into centralized database 20, a tracking component 66 for tracking information, a displaying component 68 to display information, a receiving component 70 to receive a specific query from client system 14, and an accessing component 72 to access centralized database 20. Receiving component 70 is programmed for receiving a specific query from one of a plurality of users. Server system 12 further includes a processing component 76 for searching and processing received queries against data storage device 34 containing a variety of information collected by collection component 64. An information fulfillment component 78, located in server system 12, downloads the requested information to the plurality of users in the order in which the requests were received by receiving component 70. Information fulfillment component 78 downloads the information after the information is retrieved from data storage device 34 by a retrieving component 80. Retrieving component 80 retrieves, downloads and sends information to client system 14 based on a query received from client system 14 regarding various alternatives.

Retrieving component 80 further includes a display component 84 configured to download information to be displayed on a client system's graphical user interface and a printing component 88 configured to print information.

Retrieving component 80 generates various reports requested by the user through client system 14 in a pre-determined format. System 10 is flexible to provide alternative reports and is not constrained to the options set forth above.

Database 20 is divided into a Sales Personnel Information Section (SPIS) 90, an Organizational Information Section (OIS) 94, and a Client/Lead Information Section (CLIS) 96. Sections 92, 94 and 96 within database 20 are interconnected to update and retrieve the information as required.

In an exemplary embodiment, SLMS utilizes a software that allows the user to produce a series of sales and sales management reports on demand. The software may be utilized on a stand alone computer system or may be downloaded through an intranet or the Internet. The software includes a feature for recording specific tasks that need to be completed and links these tasks to a contact. This feature helps a sales person manage their daily activity without using another software such as project management.

The software has a 4 level hierarchy with different features for level 4 sales representatives versus level 1, 2 and 3 managers. The critical aspects for managers is the ability to assign and reassign leads to lower levels and to view all activity of the lower levels reporting to them. The software provides an on-line help feature to assist the user in quick learning.

The system allows a user to import and export data from other commercial software. A user can import contact as well as sales lead information from another software program into sales tracker and can export the data from Sales Tracker to allow for custom reports and analysis. The system's flexibility permits the user or an administrator to change the user profile information including the territory the user is assigned to, the users payment information (or company's payment information), adding new users, deleting inactive users, reassigning leads from one sales representative to another. This flexibility allows the user, administrator or anyone having an authorization to make changes or enhancements.

The system further includes an enrollment process which allows the user to “sign up now and set up their account at a later time”. The enrollment process is the method of setting up the user's organizational hierarchy including all enrollees. Once the user provides initial information through a pre-determined menu, the system sets up automatically the user's accounts and the proper organizational structure based on the information. The system utilizes a database which includes a complete product catalogue allowing the user to maintain a library of products available for selling and to assign a product to a specific contact. The system provides a unique lead disposition process which provides the user with a visual flowchart of a sales process with the appropriate disposition code to use based on the stage of the process a particular deal is in allowing a user friendly approach to disposition leads in the system and a process tool to help sales people sell more systematically. The system further offers an option that provides the users with pre-qualified leads loaded into a sales representative's account and available for their follow up real time. The feature related to loading pre-qualified leads into the sales representative's account is often accomplished through the use of call center services and the integration of call management software (for e.g. Siebel 2000) with the SLMS.

SLMS architecture of system 10 as well as various components of system 10 are exemplary only. Other architectures are possible and can be utilized in connection with practicing the processes described below.

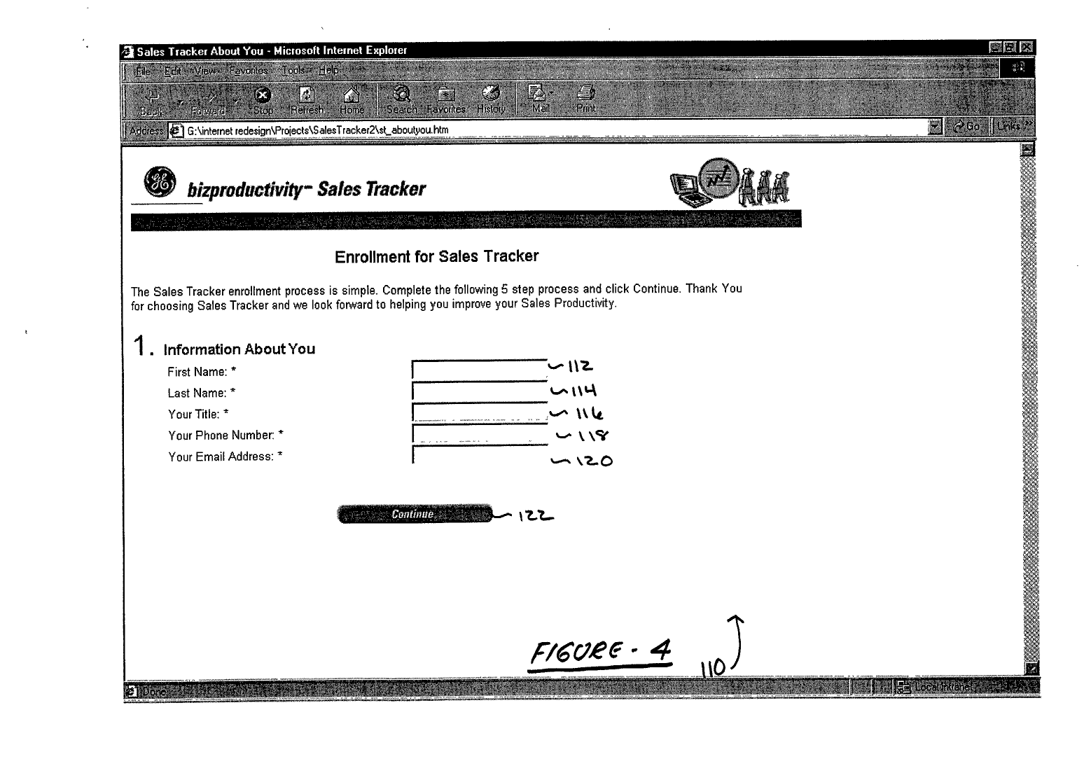

FIGS. 4 through 15 are exemplary embodiments of user interfaces utilized by the SLMS in the enrollment process. Through a series of user interfaces, the user is guided to complete the enrollment process and create a structure of the organization within the system that tracks sales leads to improve sales productivity. The information provided through the user interfaces depicted in FIGS. 4 through 15 is stored in centralized database 20 and retrieved by server system 12 as required. Many variations of particular user interfaces or screens viewable by the user can be utilized. The following description refers to one set of screens that can be used to prompt the user to make the necessary inputs to enable the system to generate various reports, charts, or status reports. Of course, many variations of such screens are possible.

Referring now specifically to the drawings, FIG. 4 is an exemplary embodiment of a first user interface 110 requesting the information about a user or a primary contact person within the organization. Through various fields of user interface 110, the user is prompted to enter the user's first name 112, a last name 114, a title 116, a phone number 118, and an e-mail address 120.

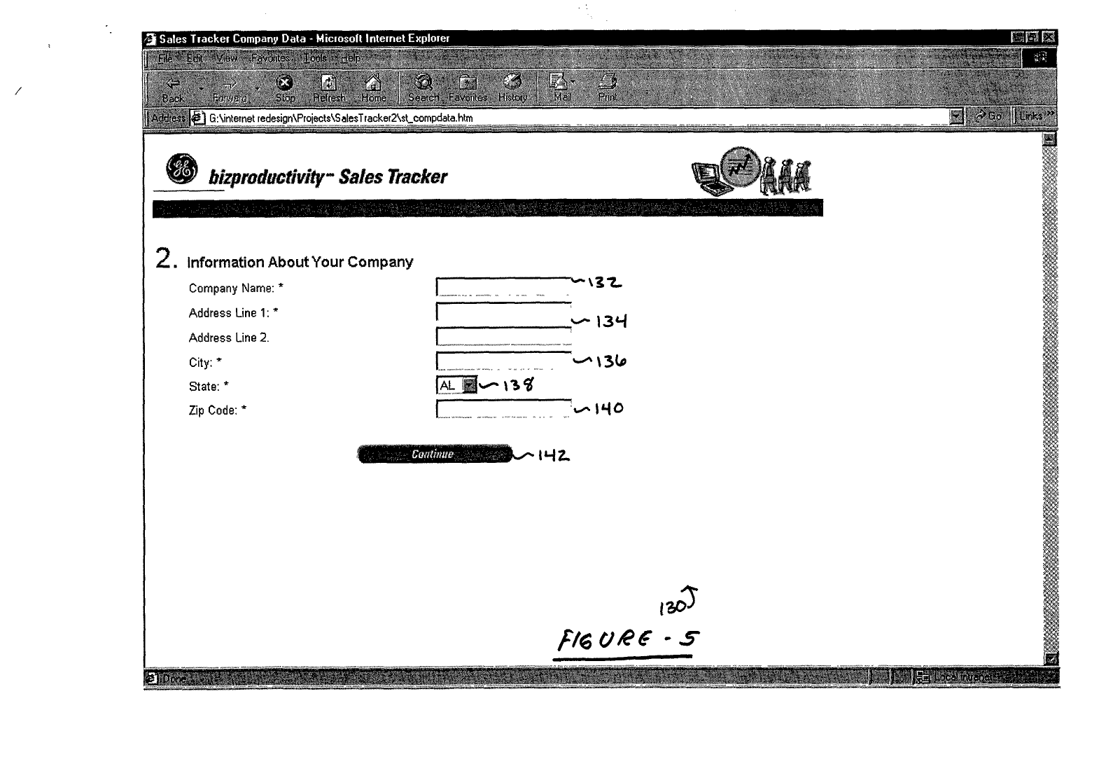

FIG. 5 is an exemplary embodiment of a second user interface 130 downloaded and displayed by server system 12 when the user selects a continue button 122 (shown in FIG. 4). The user is prompted through second user interface 130 to supply information about the user's company including a company name 132, the company's address 134, a city 136, a state 138 and a zip code 140.

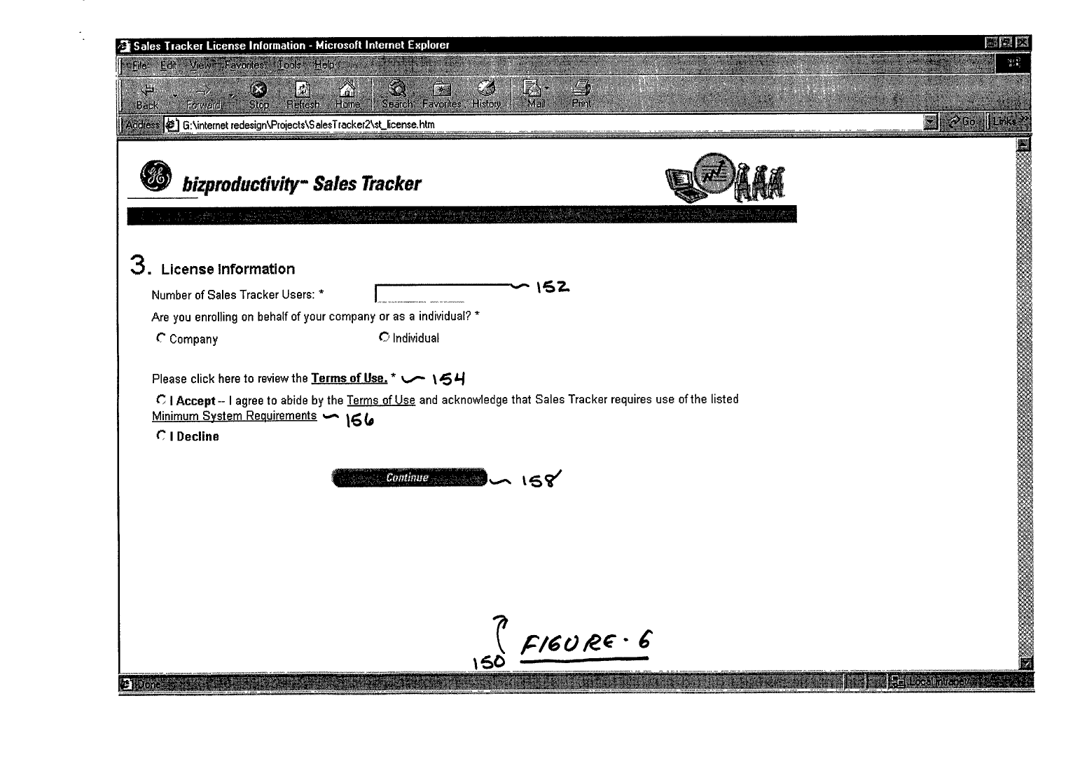

FIG. 6 is an exemplary embodiment of a third user interface 150 downloaded and displayed by server system 12 when the user selects a continue button 142 (shown in FIG. 5). The user is prompted through third user interface 150 to supply information about a number of sales tracker users within the company 152, and clarification regarding whether the user is enrolling into the program as an individual or as a company through a plurality of fields. Through user interface 150, the user has an option to review the terms of use 154, which the user may access through a hypertext link, and either decline or accept the terms of use. System requirements may also be accessed by the user through a separate hypertext link entitled “Minimum System Requirements” 156.

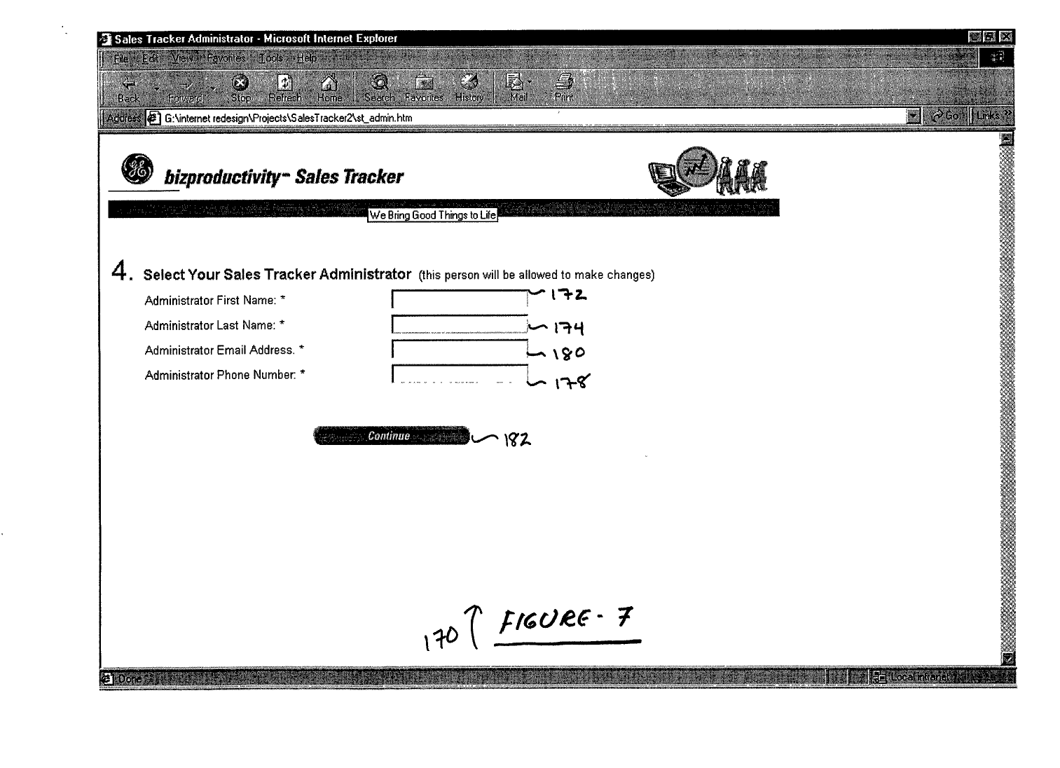

FIG. 7 is an exemplary embodiment of a fourth user interface 170 downloaded and displayed by server system 12 when the user selects a continue button 158 (shown in FIG. 6). The user is prompted through fourth user interface 170 to supply information about administrator's first name 172, a last name 174, a phone number 178, and an e-mail address 180. Selection of a continue button 182 transmits the message to server system 12 to download and display a next user interface.

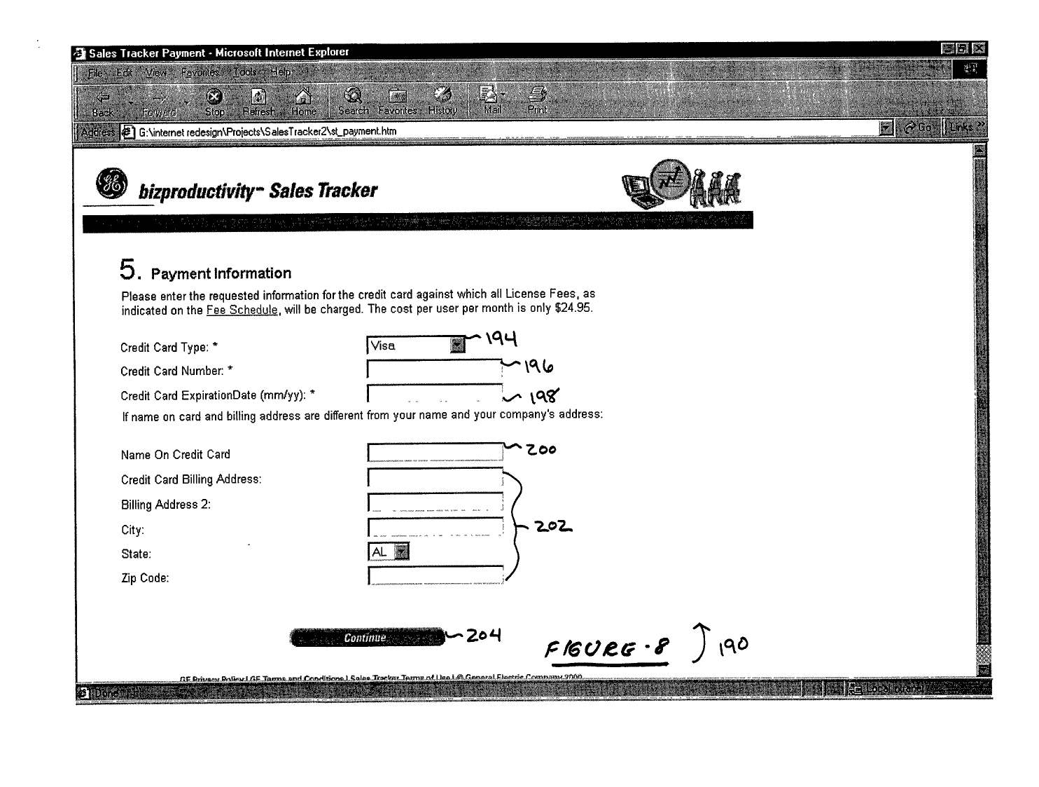

FIG. 8 is an exemplary embodiment of a fifth user interface 190 downloaded and displayed by server system 12 when the user selects a continue button 182 (shown in FIG. 7). The user is prompted through fifth user interface 190 to supply information about a user's payment information which includes, user's Credit Card Type 194, Credit Card Number 196, Expiration Date 198, Name on the Credit card 200, and Credit Card Billing Address including City, State and Zip Code 202. Selection of a continue button 204 transmits the message to server system 12 to download and display a next user interface.

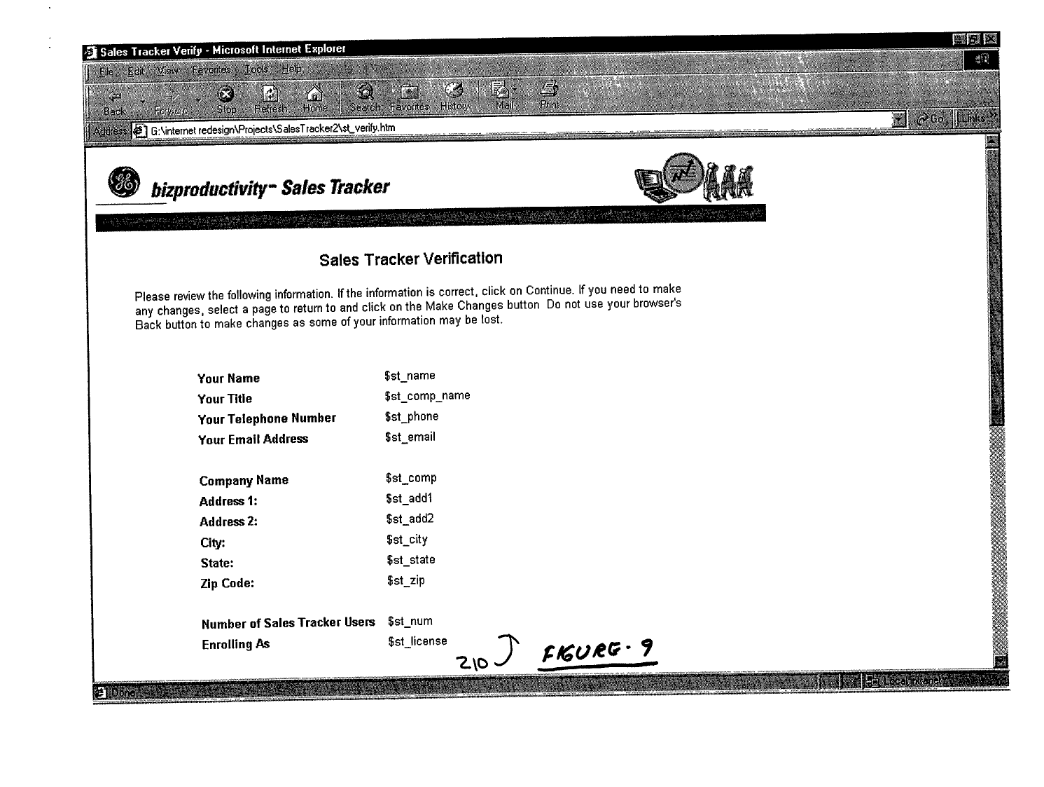

FIG. 9 is an exemplary embodiment of a sixth user interface 210 downloaded and displayed by server system 12 when the user selects a continue button 204 (shown in FIG. 8). Sixth user interface 210 displays all the information provided by the user and provides the user with an option to modify the information, if necessary by returning to the previous user interfaces.

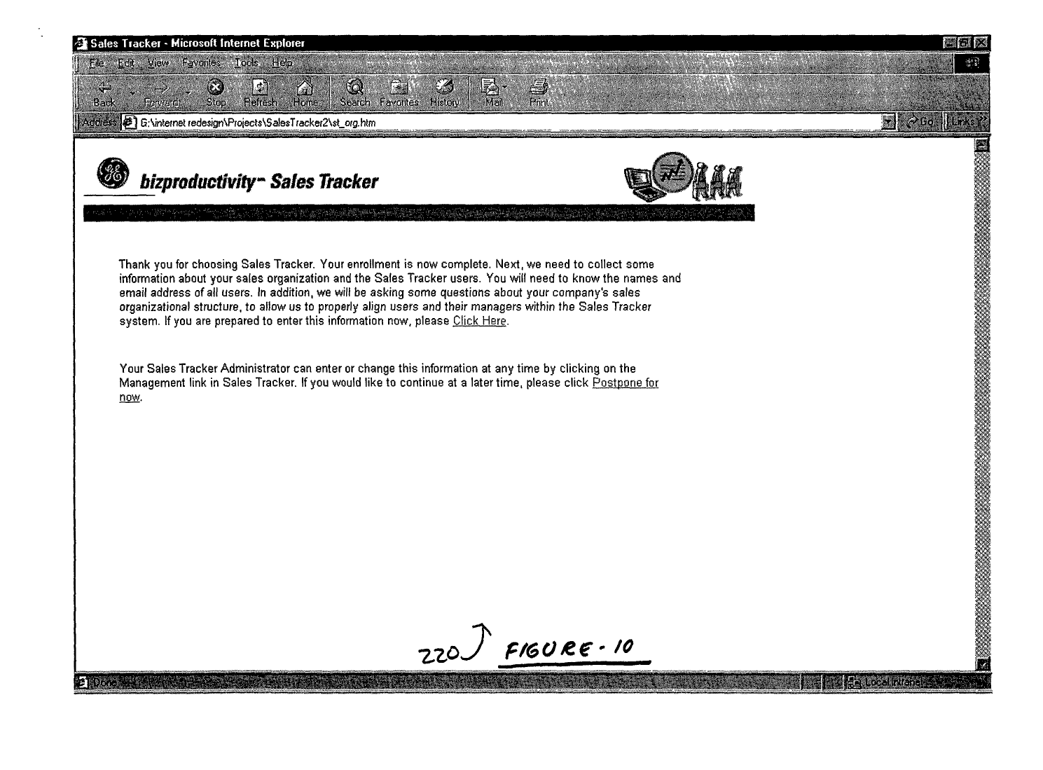

FIG. 10 is an exemplary embodiment of a seventh user interface 220 downloaded and displayed by server system 12 when the user has completed the enrollment process. Seventh user interface 220 displays a thank you message and provides the user with an option to access another user interface through a hypertext link for entering essential information about the sales organization structure. The user may decide to stop at this juncture and enter this information at a later date.

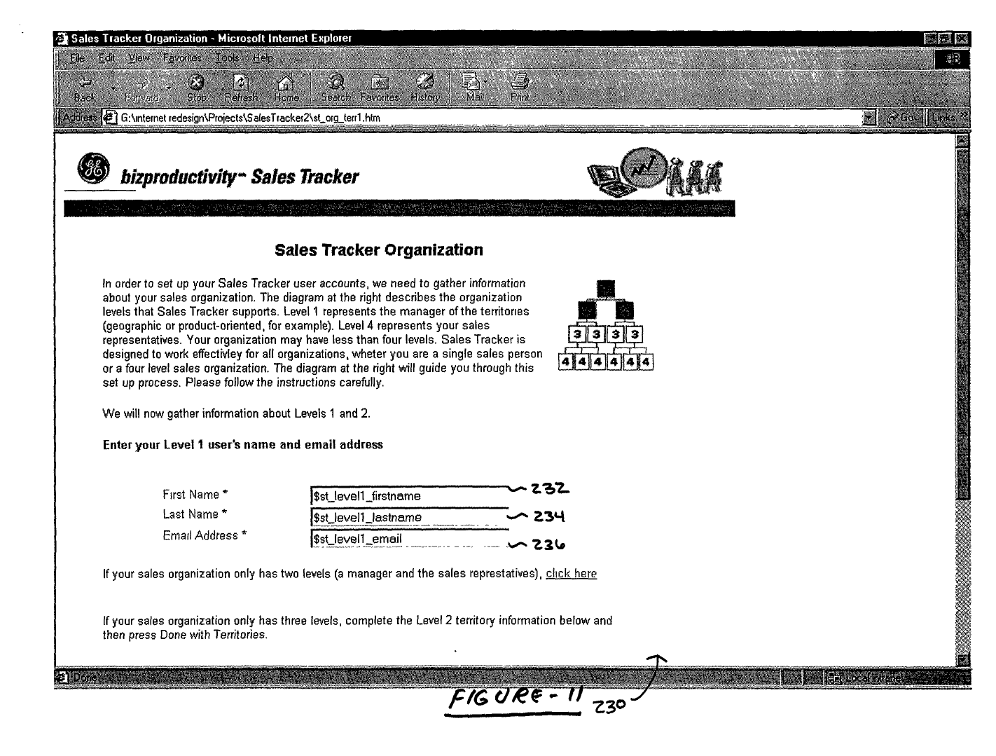

FIGS. 11 through 15 are exemplary embodiments of user interfaces that allow the user to set up Sales Tracker user accounts by providing an organizational structure of the sales force that will be utilizing sales tracker.

FIG. 11 is an exemplary embodiment of a user interface 230 depicting a sales tracker organization set up screen. Level 1 represents the manager of the territories. Level 4 represents sales representatives. The organization may have less than 4 levels. SLMS 10 is designed to work effectively for all organizations, whether the organization is a single person organization or an organization involving numerous sales representatives working in different regions or territories. Through user interface 230 the user provides a Level 1 user's first name 232, a last name 234, and an e-mail address 236.

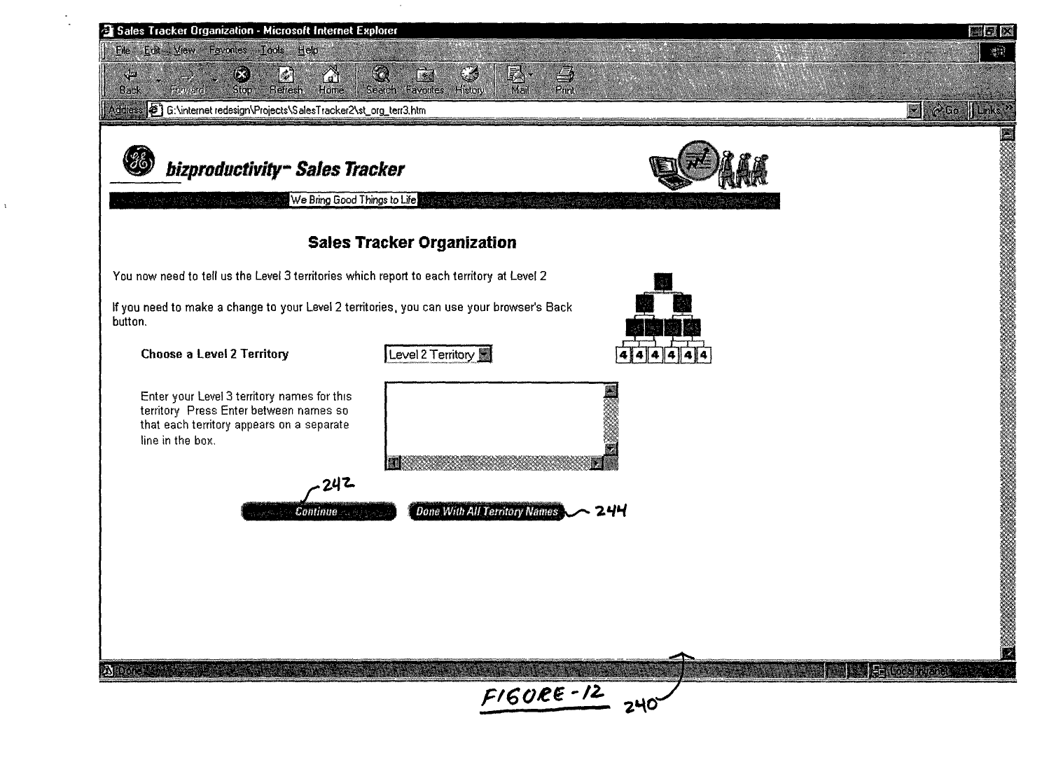

FIG. 12 is an exemplary embodiment of a user interface 240 prompting the user to supply information on level 2 and level 3 territories. The user may continue by selecting a continue button 242 for adding territories or stop the process for adding additional territories by selecting a button 244.

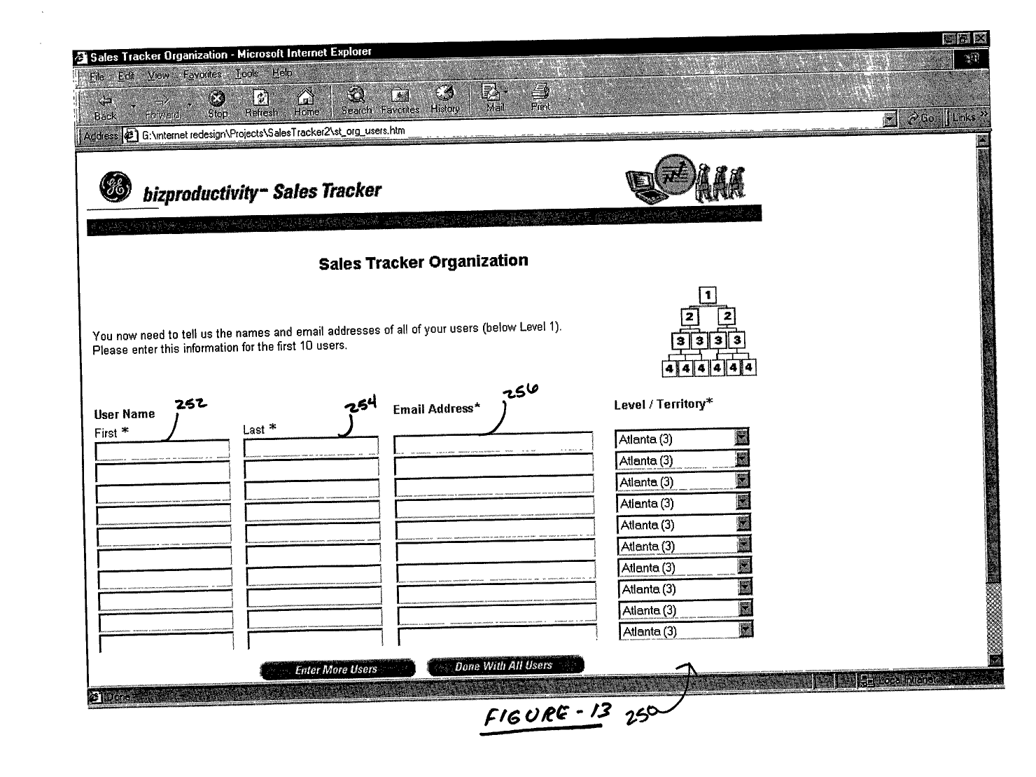

FIG. 13 is an exemplary embodiment of a user interface 250 for providing detail information about every user using SLMS. The user supplies a first name 252, a last name 254, an e-mail address 256, and identify a level as well as territory for each name entered into the database. The user has an option to supply more names or end the process by selecting an appropriate button.

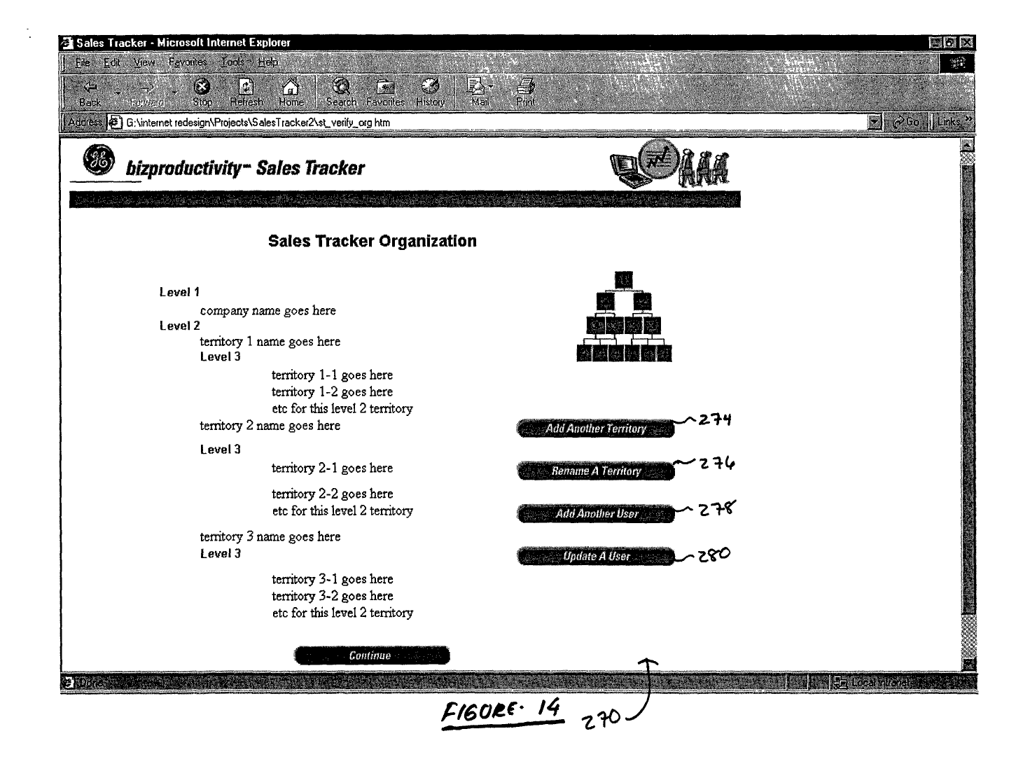

FIG. 14 is an exemplary embodiment of a user interface 270 detailing the organization structure as entered by the user. The user reviews the information and may modify the information as appropriate by adding another territory 274, renaming a territory 276, adding another user 278, or updating a user 280.

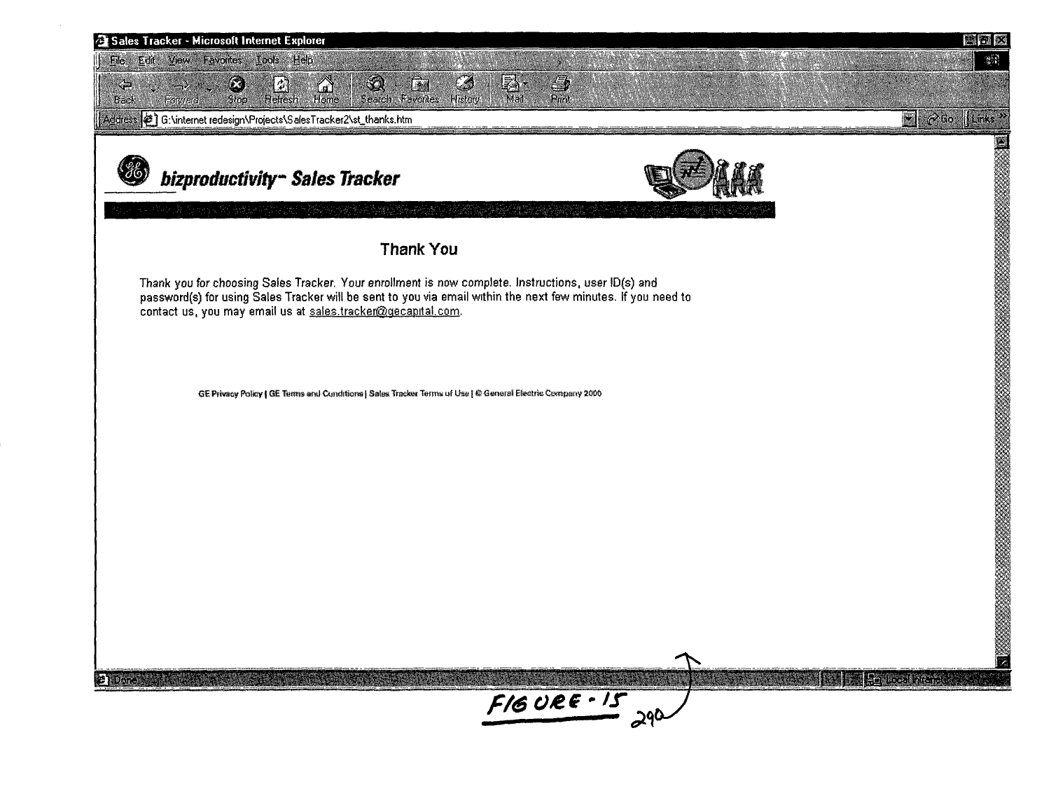

FIG. 15 is an exemplary embodiment of a user interface 290 displaying a thank you message once the enrollment is complete informing the user that the enrollment is complete and that the user may now use the system to track sales leads.

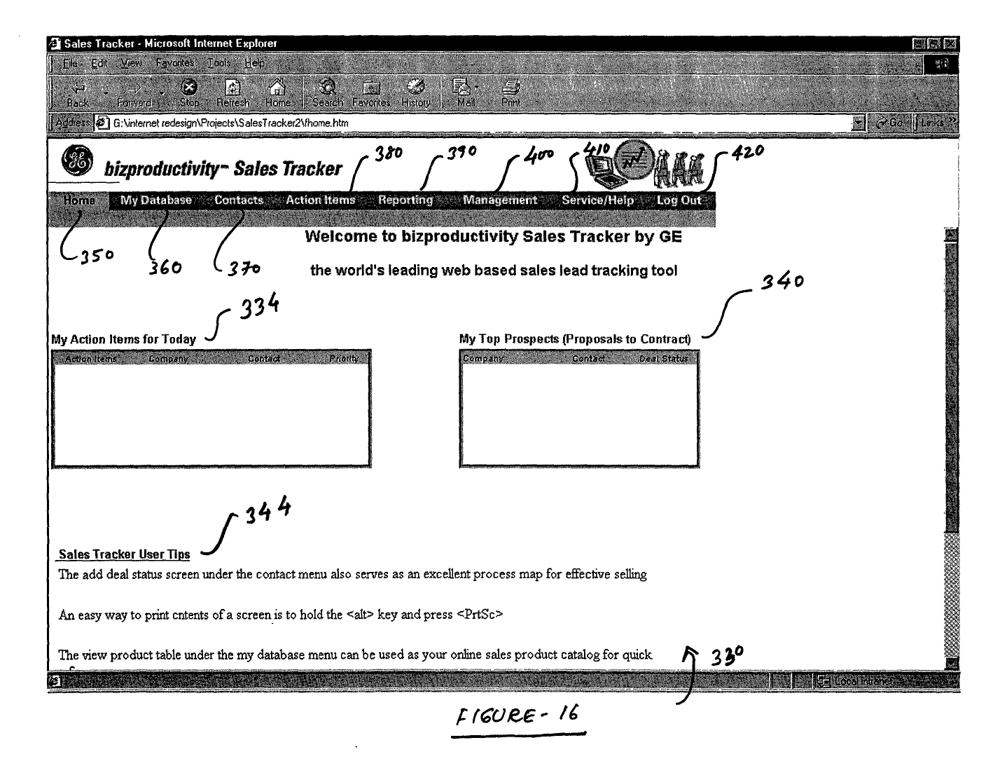

FIG. 16 is an exemplary embodiment of a user interface, also known as a home page 330 of SLMS 10 shown in FIG. 2. Home page 330 is displayed once the user has logged onto the system and the system has authenticated the user after verifying user's identification name and a password. If the user is not authenticated, system 10 displays a message to the user advising to log in again. The home page displays several navigational buttons or hypertext links at top of the page. Home page 330 downloads and displays a section for “My Top Action Items” 334 and another section for “My Top Prospects” 340. “My Top Action Items” 334 shows the actions that have been created by the logged in user that are still open. Top actions 334 are displayed chronologically in ascending order (past, present and then future). “My Top Prospects” 340 shows deals that are not closed or lost, showing the deals with the highest deal amount for this contact. New users do not have anything displayed in these blocks. Home page 330 along with graphics, also displays a hypertext link “Sales Tracker User Tips” 344 for the user. In yet another embodiment, once a user has been authenticated, the user is directed to the main web site (www.bizproductivity.com) customer center. From the customer center user interface, the user selects Sales Tracker as the service the user wishes to access, which connects the user to the home page. It will be recognized by those skilled in the art that there are multiple other possible embodiments that can be utilized in securing the system as well as accessing the home page through the secured system.

In an exemplary embodiment, home page 330 utilizes a top frame when the user logs in with the user's password. The top frame utilizes eight different navigational buttons or tabs to guide the user through these various sections. These sections include, but are not limited to, “Home” 350, “My Database” 360, “Contacts” 370, “Action Items” 380, “Reporting” 390, “Management” 400, “Service/Help” 410 and “Log Out” 420. Each navigational button permits the user to get back to the screen from any other screen in the system. Home 350 takes the user back to home page 330.

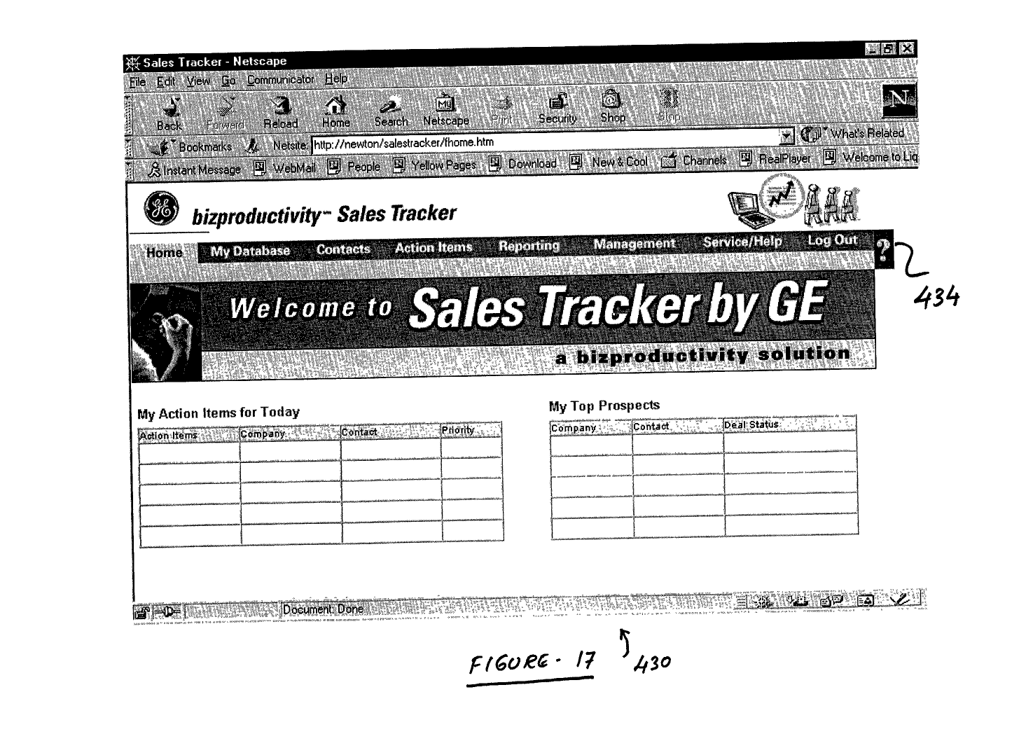

FIG. 17 is an alternative exemplary embodiment of home page user interface 430 of SLMS 10 shown in FIG. 2. Home page user interface 430 navigational bar has all the features that are available on home page 330 (shown in FIG. 16) in addition to online help function that can be accessed when the user double clicks on a Question Mark (?) 434. Through online help function, the user can address a variety of issues that the user may encounter during the operation. Online help provides step by step approach to the user in addressing a specific issue. It also provides guideline to the user in viewing the data, making changes to the data, qualifying data, closing a deal, creating reports, managing data, and managing the organization. Appendix A includes various online help screens available to the user. Even though, many user interfaces shown below, do not indicate a question mark symbol for online help, adding this particular function can be achieved without compromising other functionality of the system.

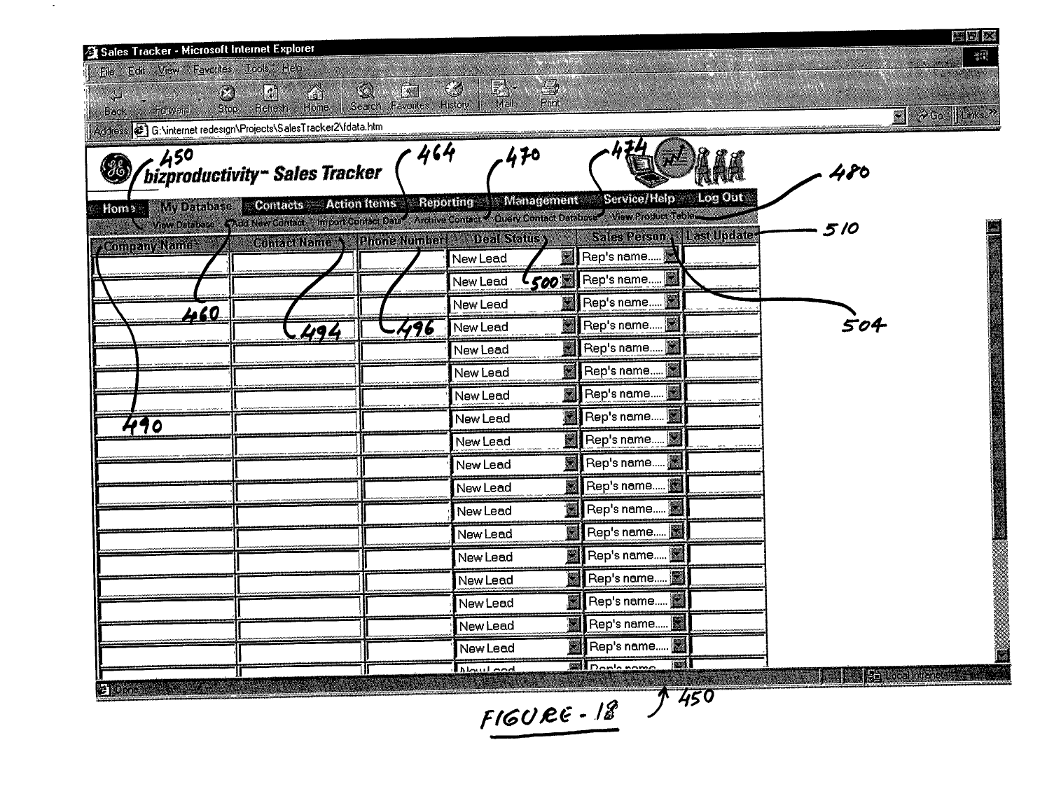

FIGS. 18 through 23 are exemplary embodiments of various subsections of “My Database” 360 (shown in FIG. 16). For example, FIG. 18 is an exemplary embodiment of a “View Database” user interface 450 providing the user with an ability to perform several functions pertaining to the user's own database maintained within database 20. “View Database” user interface 450 is one of a subsection of “My Database” 360 (shown in FIG. 16). “My Database” 360 also provides the user with an option to perform many different functions including, but not limited to, Add New Contact 460, Import Contact Data 464, Archive Contact 470, Query Contact Database 474, and View Product Table 480. Additionally, online help function is also accessible to the user by double clicking a Question Mark (?) (not shown). Once the user double clicks the question mark and invokes online help function, the user is directed to a set of online help screens shown in Appendix A. Import Contact Data 464 allows the user to upload contacts in batch from the various formatted files. Archive Contact 470 archives records and displays the records when archived records are requested. When a contact is archived, all notes, action items, products and deal status history associated with that contact is also archived. If the user goes to Archive Contact 470 from the View Database selection, the data on that page should be refreshed to exclude all archived records. Query Contact Database 474 allows the user to query database 20 through a variety of methods. System 10 screens the data based on the user's established level. For example, if the user is a Level 1 user, the user will be able to view all the data. However, if the user is a level 4 user, system 10 does not display the salesperson selection to the user. View Product Table 480 is a display only view of the Product Table that is maintained under Management-Update Product Table. Selecting the column headings allows the user to sort based on the selected fields.

User interface 450 displays the user's own personal database which includes a Company Name 490, a Contact Name 494, a Phone Number 496, a Deal Status 500, a name of a Sales Person 504, and a date on which this particular deal status was last updated 510 by the user.

If the user is a salesperson, the salesperson column is not displayed. If the user is a management member having a direct authority over various sales personnel, a name of the sales person responsible for this specific account is displayed. System 10 only displays the current data and not the archived records unless the user specifically requests to display archived records. Selecting Contact Name 494 takes the user to Contacts, View Notes. Deal status 500 and salesperson 504 columns contain pull down menus allowing the user to make changes. Salesperson 504 column pull down menus are populated with the names of the salespersons in the user's territory and the word Unassigned. Deal status 500 pull down menus are pre-populated with the following: Unassigned, New Lead, Attempt Contact, Qualified Lead, Not Qualified, Proposal Sent, Proposal Accepted, Contract Pending, Closed Sale, Loss, Archived. This allows the user an opportunity to record the current status against each company name 490. Last update date 510 is used to show when a contact has been ‘touched’. This field is updated when a deal status is changed or when an action item for the contact has been completed. This field cannot be edited by the user and is updated automatically by system 10.

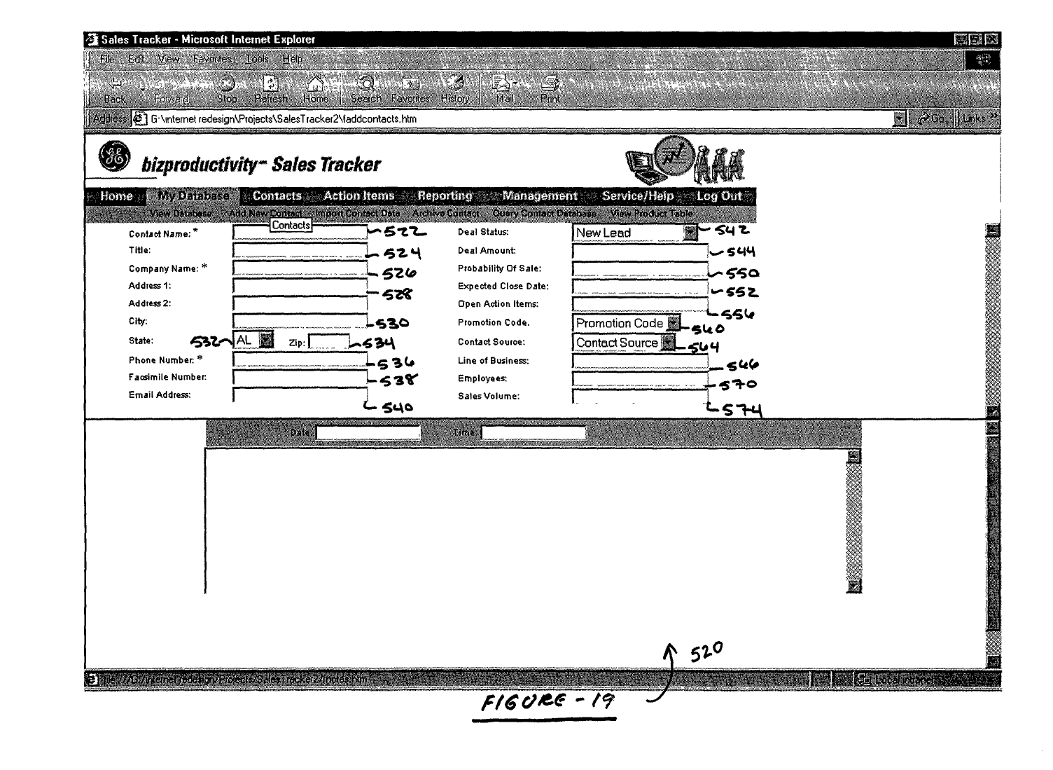

FIG. 19 is an exemplary embodiment of an “Add New Contact” user interface 520 providing the user with an ability to add new contacts into database 20. “Add New Contact” user interface 520, a blank contact page, is one of a sub-section of “My Database” 360 (shown in FIG. 16). System 10 downloads and displays a blank page prompting the user to supply required information which includes a Contact Name 522, a Title 524, a Company Name 526, a Company Address 528 including a City Name 530, a State 532, and a Zip Code 534. System 10 further displays a Phone Number 536, a Fax Number 538, an E-Mail address 540, Deal Status 542, Deal Amount 544 that can be realized if the deal is closed, Probability of Sale 550, Expected Close Date 552, Open Action Items 556, a Promotion Code 560, a Contact Source 564, a Line of Business 566, a number of Employees 570 and Sales Volume 574 of the business.

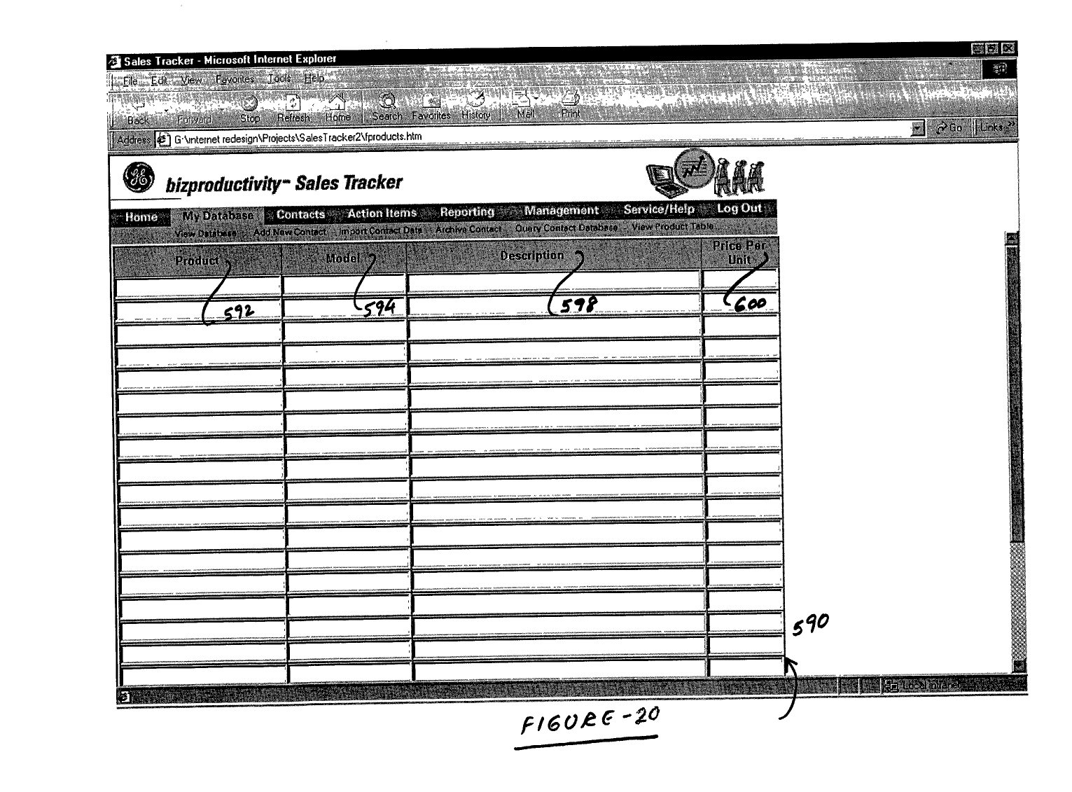

FIG. 20 is an exemplary embodiment of a “View Product table” user interface 590 providing the user with an ability to view various products from database 20. “View Product table” user interface 590 is one of a sub-section of “My Database” 360 (shown in FIG. 16). User interface 590 displays a name of a Product 592, a Model Number 594, Description of the Product 598 and Price per Unit 600. User interface 590 is a display only view of the Product Table that is maintained under Management-Update Product Table. Selecting the column headings allows the user to sort based on that specific field.

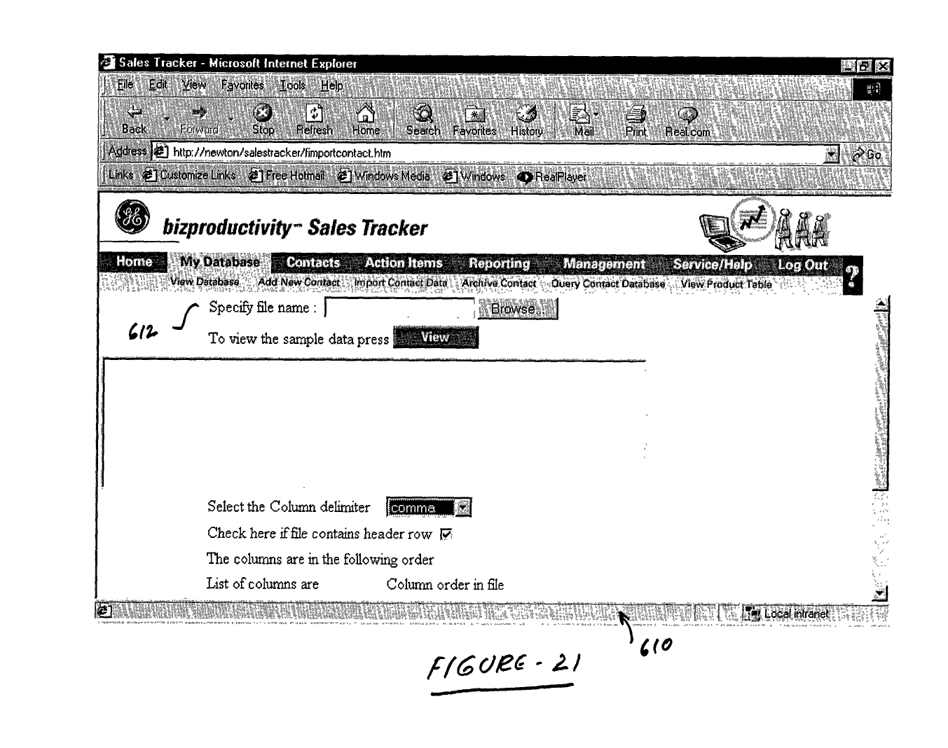

FIG. 21 is an exemplary embodiment of an “Import Contact Data” user interface 610 providing the user with an ability to import contact data from database 20. “Import Contact Data” user interface 610 is one of a sub-section of “My Database” 360 (shown in FIG. 16). User interface 610 requests the user to specify a file name 612. Once the user specifies file name 612, the user sends a request to server system to import the contact data. The system displays the data in a pre-organized sequence.

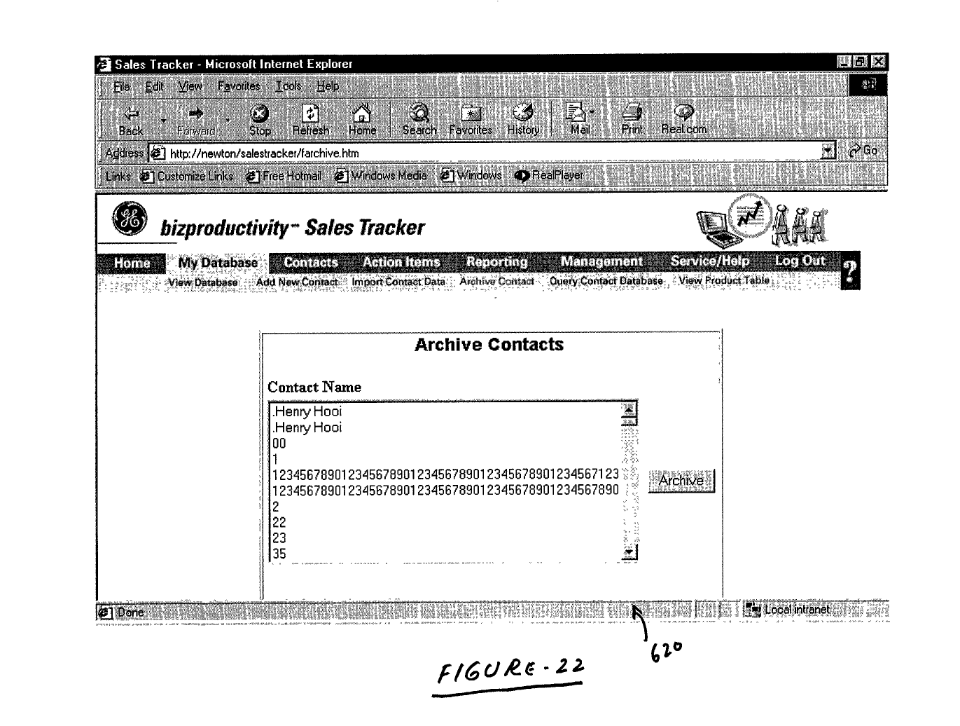

FIG. 22 is an exemplary embodiment of an “Archive Contacts” user interface 620 providing the user with an ability to archive contact data to database 20. “Archive Contacts” user interface 620 is one of a sub-section of “My Database” 360 (shown in FIG. 16).

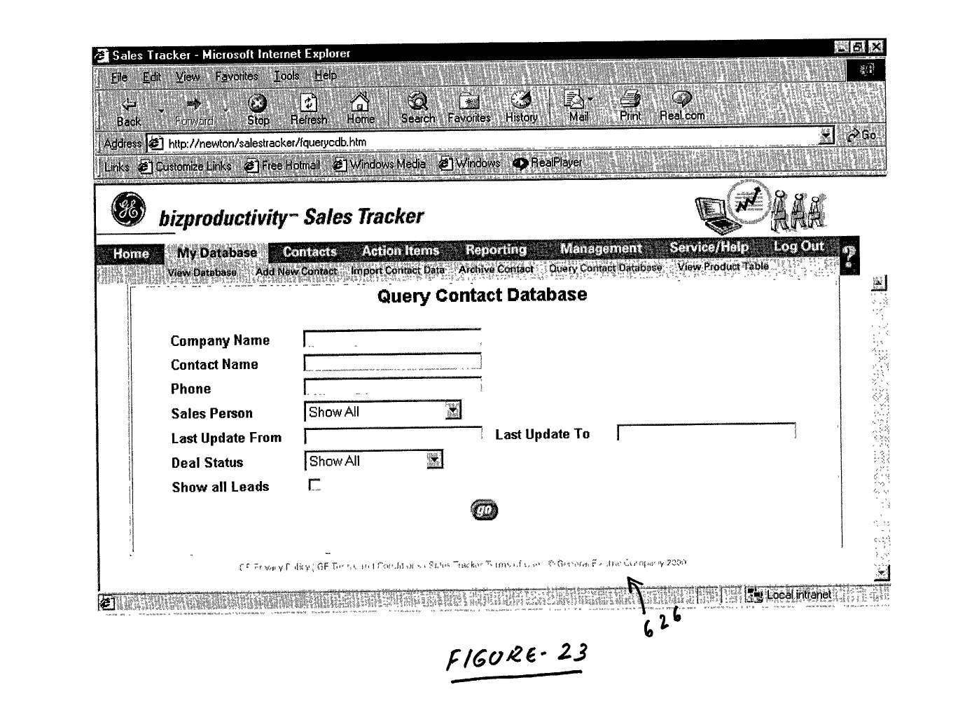

FIG. 23 is an exemplary embodiment of a “Query Contact Database” user interface 626 providing the user with an ability to query contacts from database 20. “Query Contact Database” user interface 626 is one of a sub-section of “My Database” 360 (shown in FIG. 16). User interface 626 requests from the user specific information such as a Company Name, a Contact Name, a Phone Number and other relevant information. Once the user submits this information by selecting a go button, server system 12 downloads the requested information to the user on user's display. The user has an option to query the database for a single sales representative or all the sales representatives. The user may also download the leads for a selected period.

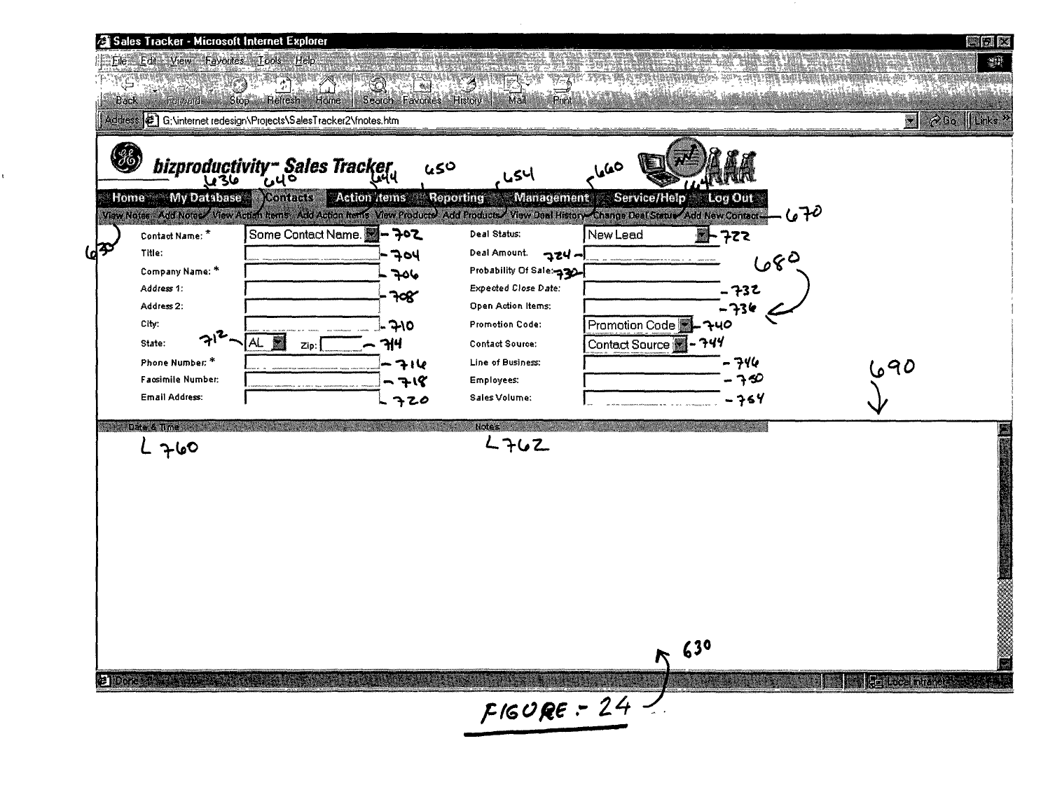

FIGS. 24 through 32 are exemplary embodiments of various subsections of “Contacts” 370 (shown in FIG. 16). For example, FIG. 24 is an exemplary embodiment of a “View Notes” user interface 630 providing the user with an ability to view various notes stored in database 20. “View Notes” user interface 630 is one of a sub-section of “Contacts” 370 (shown in FIG. 16). “Contacts” 370 section provides the user with an option to perform many different functions including, but not limited to, View Notes 630, Add Notes 636, View Action Items 640, Add Action Items 644, View Products 650, Add Products 654, View Deal History 660, Change Deal Status 664, and Add New Contact 670. The user may access each of these sub-section by selecting that specific sub-section button located at the top portion of the user interface.

Each sub-section of Contacts 630 section is divided into an Upper Half Section 680 and a Lower Half Section 690. Upper Half Section 680 displays a Contact Name 702, a Title 704, a Company Name 706, a Company Address 708 including a City Name 710, a State 712, and a Zip Code 714. System 10 further displays a Phone Number 716, a Fax Number 718, an E-Mail address 720, Deal Status 722, Deal Amount 724 that can be realized if the deal is closed, Probability of Sale 730, Expected Close Date 732, Open Action Items 736, a Promotion Code 740, a Contact Source 744, a Line of Business 746, a number of Employees 750 and Sales Volume 754 of the business. Lower Half Section 690 displays different information from sub-section to sub-section.

Lower Half Section 690 of “View Notes” user interface 630 displays Date and Time 760 and Notes 762. Clicking on date and time 760 allows the user to edit particular notes entry by taking the user to Notes-Add (it has the information pre-filled so they can change the notes but not the date or the time).

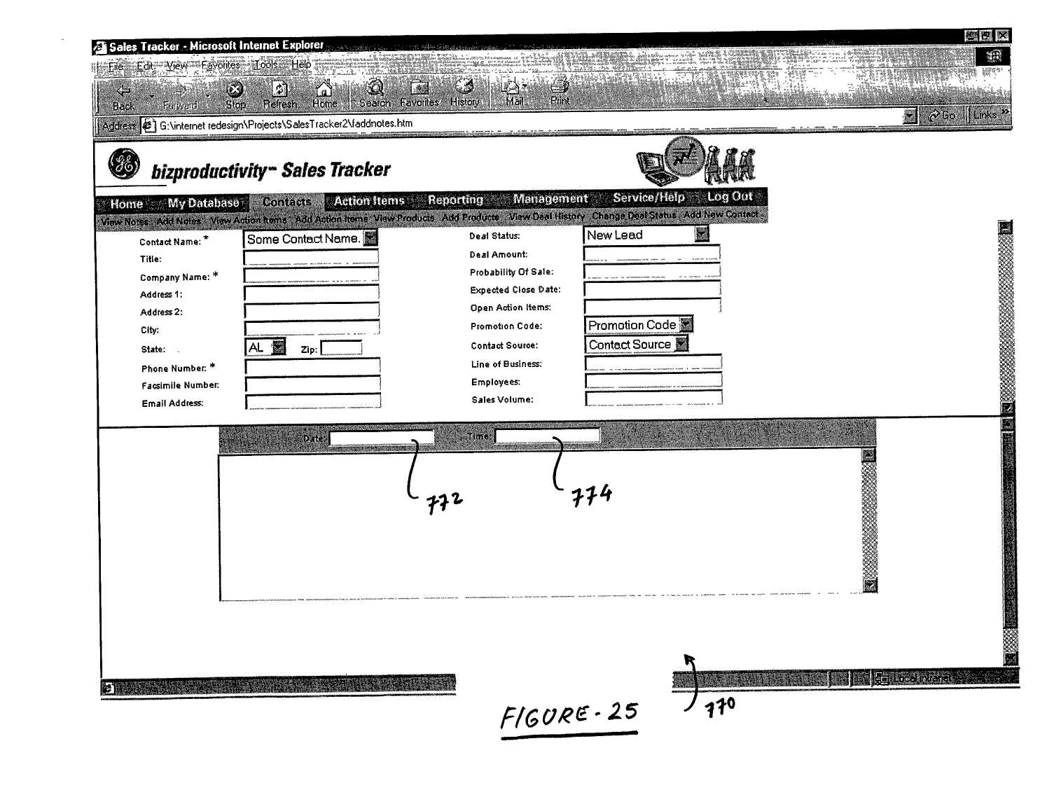

FIG. 25 is an exemplary embodiment of an “Add Notes” user interface 770 providing the user with an ability to add notes to database 20. “Add Notes” user interface 770 is one of a sub-section of “Contacts” 370 (shown in FIG. 16). Add Notes user interface 770 is used for both add and edit mode. There is no limit to the number of lines that can be added for notes unless there is a system limit. A Date 772 and Time 774 is filled in automatically with today's date and current time, but user is allowed to change them (in add mode only).

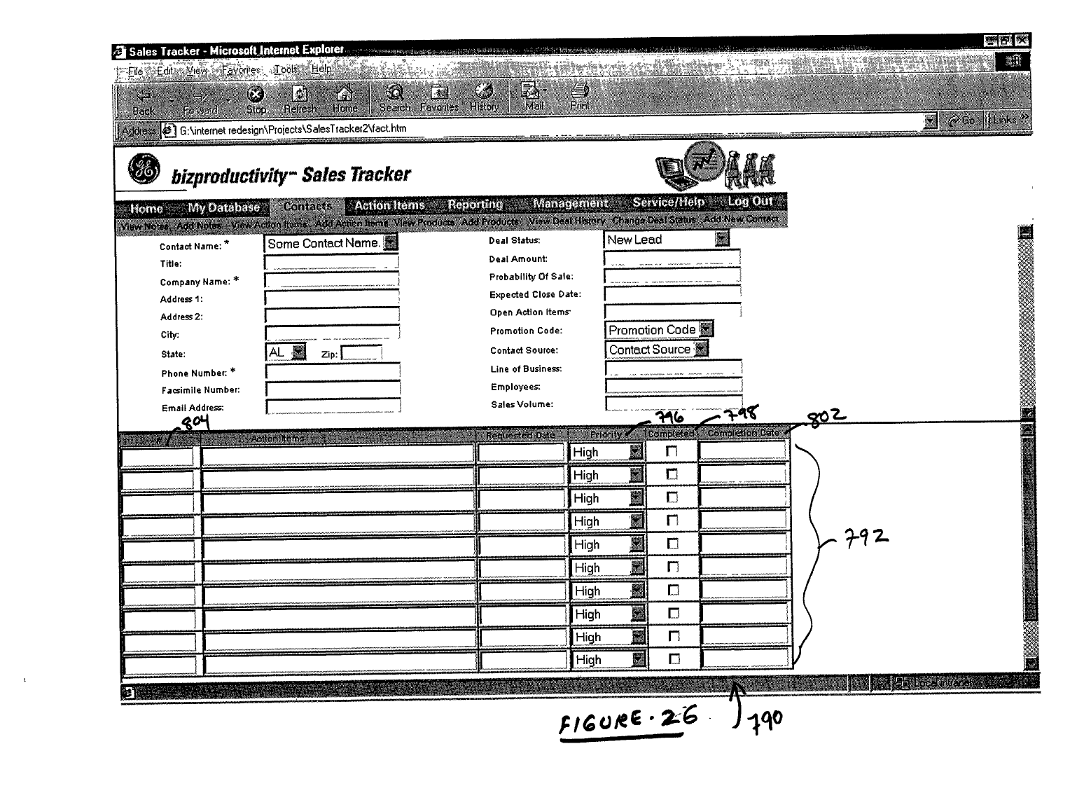

FIG. 26 is an exemplary embodiment of a “View Action Items” user interface 790 providing the user with an ability to View Action Items stored in database 20. “View Action Items” user interface 790 is one of a sub-section of “Contacts” 370 (shown in FIG. 16). View Action Items user interface 790 displays the action items 792 list in a chronological order. Selecting column headings sorts the list. A priority field 796 is a pull down menu populated with Priority selection 1—High, 2—Moderate, 3—Low. In an exemplary embodiment of the invention, a Completed field 798 is a check box. When a user completes an action item, the user checks the box. If the user checks the Completed box, Actual Completion Date 802 is automatically filled in with today's date and the user is taken to Completion Date 802 field so the user may change it. Selecting an item in the Actions # column 804 takes user back to the edit mode.

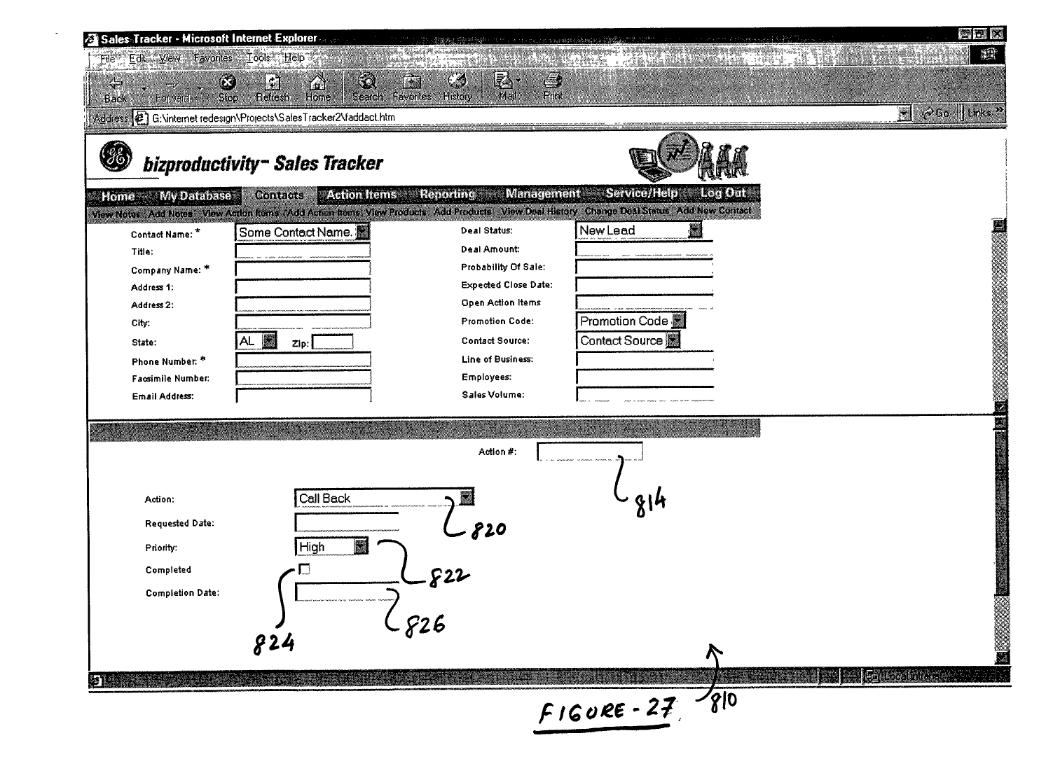

FIG. 27 is an exemplary embodiment of an “Add Action Items” user interface 810 providing the user with an ability to Add Action Items to database 20. “Add Action Items” user interface 810 is one of a sub-section of “Contacts” 370 (shown in FIG. 16). Add Action Items user interface 810 is utilized for add and edit mode. Action#814 is generated by system 10 and is for display only. Action #814 is unique for the current contact only. Action 820 is a pull down menu with the selections of Call Back, Appointment, Create Proposal, Send Contract, Thank You Letter, Awaiting Customer Response, and <Add New>. The newly added action items are shared by all the users for that company. Priority 822 is a pull down menu with the same selections as Action Items page. If a Completed box 824 is checked by the user, then an actual completion date 826 is filled out by system 10.

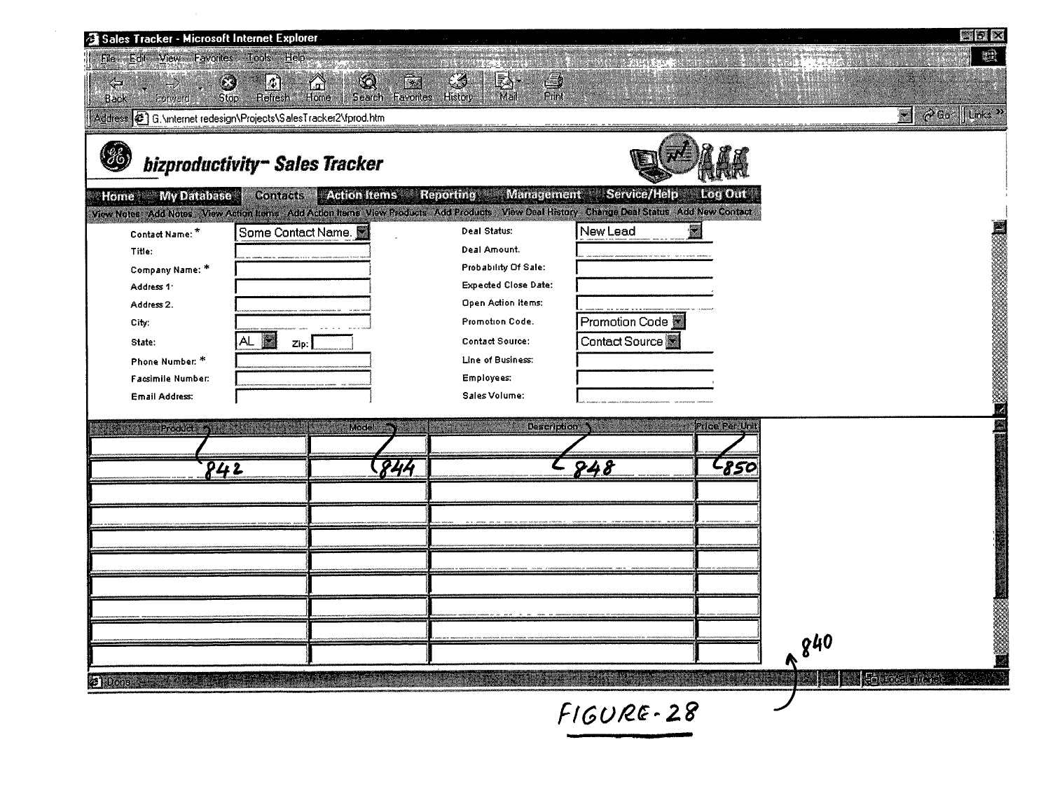

FIG. 28 is an exemplary embodiment of a “View Products” user interface 840 providing the user with an ability to view products from database 20. “View Products” user interface 840 is one of a sub-section of “Contacts” 370 (shown in FIG. 16). View Products user interface 840 displays a product list in the order it was entered to start. View Products user interface 840 also displays several column headings for Product 842, Model Number 844, Description of the Product 848, and a Price per Unit 850. Selecting the column heading sorts the list. Selecting product 842 and making an entry in the list takes the user to the Add Products user interface (shown in FIG. 25) where the user can change the list of products.

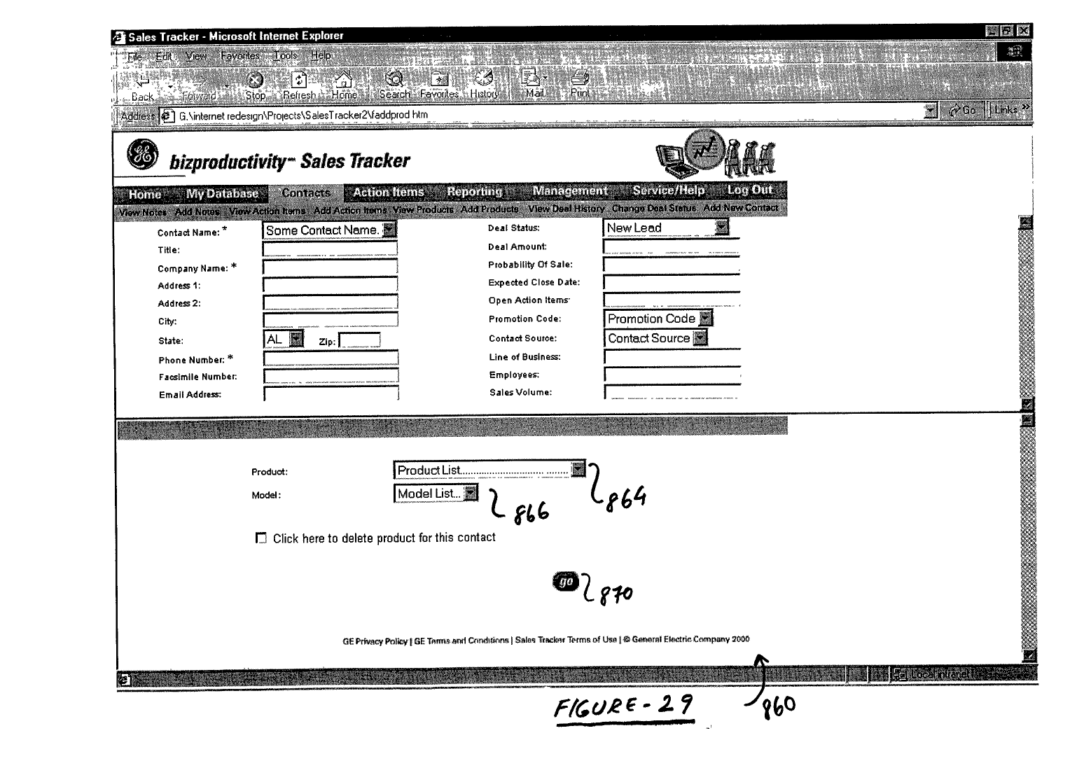

FIG. 29 is an exemplary embodiment of an “Add Products” user interface 860 providing the user with an ability to add products against a specific contact into database 20. Add Products user interface 860 is one of a sub-section of “Contacts” 370 (shown in FIG. 16). Add Products user interface 860 is used for both add and edit. A product 864 and a model 866 are to be selected from a pull down list using information entered on the Products Main page. In order to delete product 864 from the list, the user checks the delete box and then selects a “go” button 870.

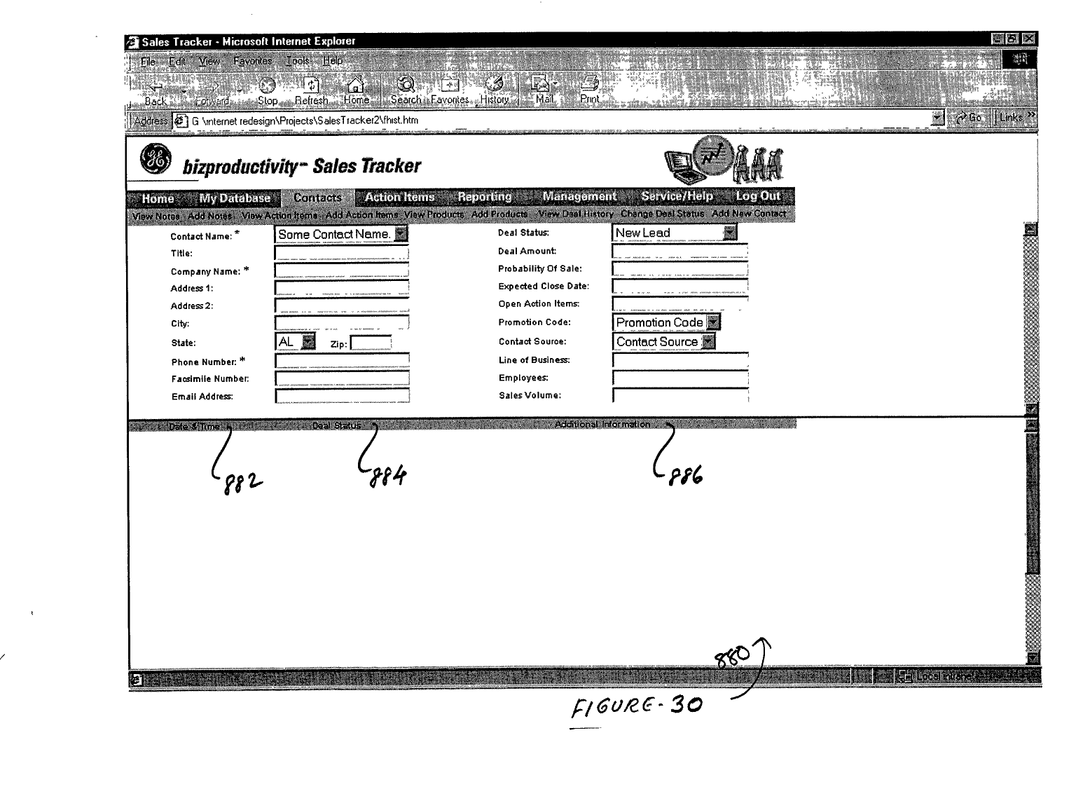

FIG. 30 is an exemplary embodiment of a “View Deal History” user interface 880 providing the user with an ability to view deal status against a specific contact into database 20. View Deal History user interface 880 is one of a sub-section of “Contacts” 370 (shown in FIG. 16). View Deal History user interface 880 displays a Date and Time 882, Deal Status 884, and any Additional Information 886 that exists on the deal. View Deal History user interface 880 is a display only screen showing deal status. The list is displayed in ascending chronological order.

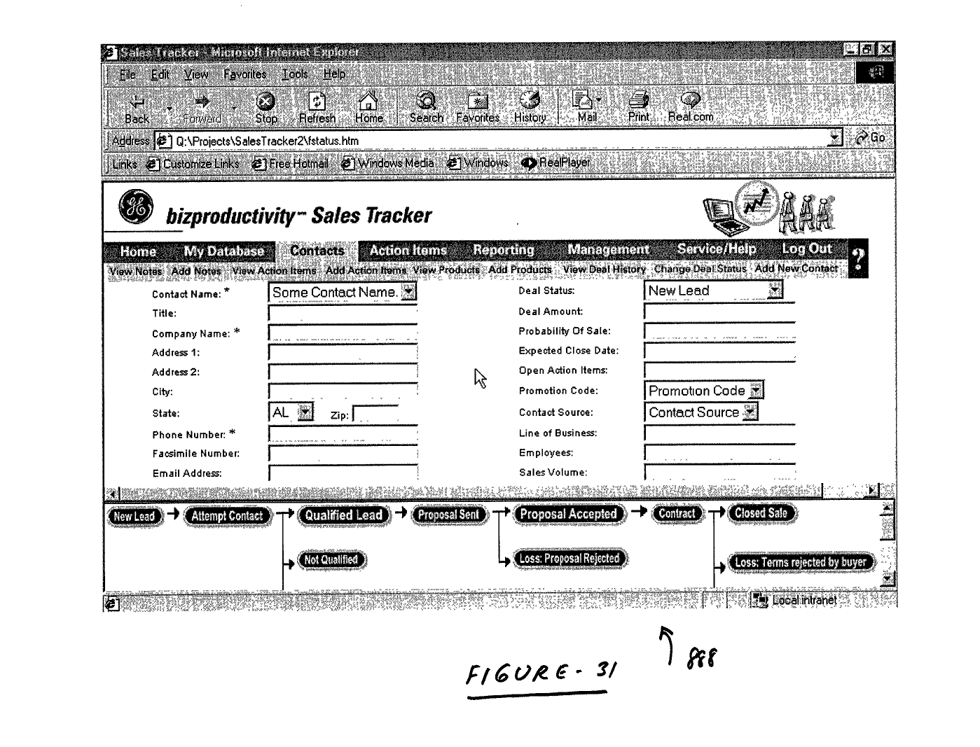

FIG. 31 is an exemplary embodiment of a “Change Deal Status” user interface 888 providing the user with an ability to change deal status from one stage to another. Change Deal Status user interface 888 allows the user to change the status of the current deal and transmits the updated status change to database 20.

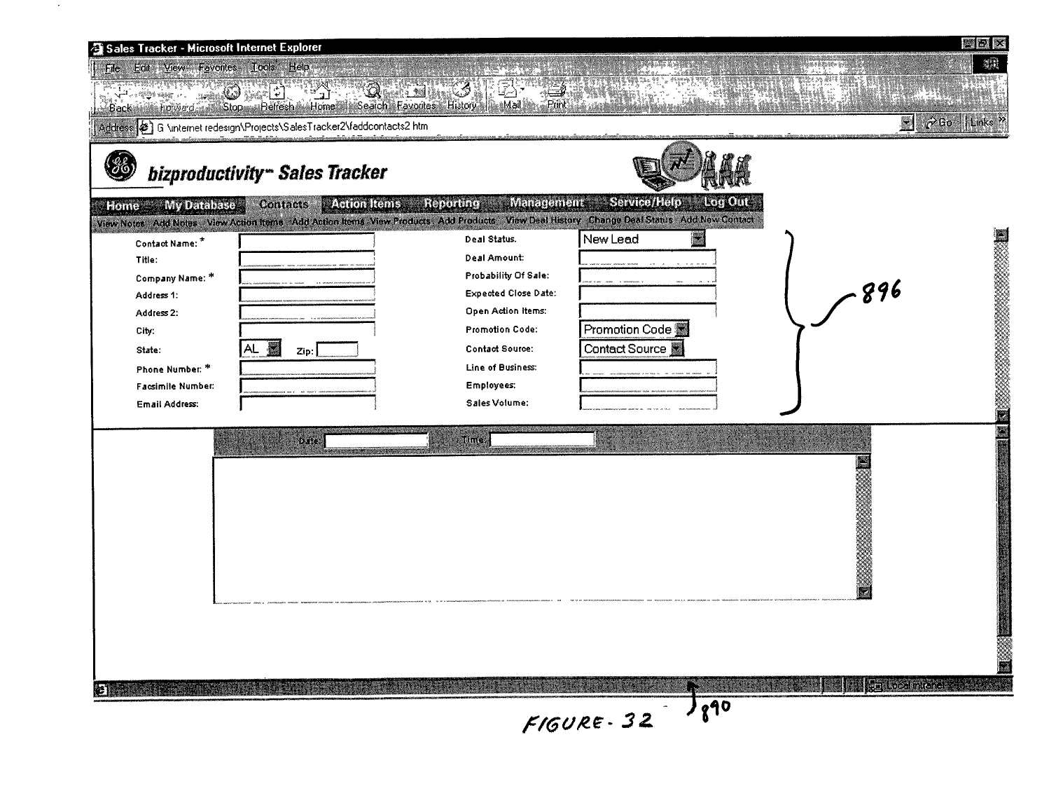

FIG. 32 is an exemplary embodiment of an “Add New Contact” user interface 890 providing the user with an ability to view add new contact against a specific deal into database 20. Add New Contact user interface 890 is one of a subsection of “Contacts” 370 (shown in FIG. 16). Add New Contact user interface 890 displays a blank Contacts page 896 and allows the user to type in the information relating to that contact in the top half frame. The information that the user inputs in blank contact page 896 includes, Contact Name 702 (shown in FIG. 20), Title 704, Company Name 706, Company Address 708 including City Name 710, State 712, and Zip Code 714. System 10 further displays Phone Number 716, Fax Number 718, E-Mail address 720, Deal Status 722, Deal Amount 724 that can be realized if the deal is closed, Probability of Sale 730, Expected Close Date 732, Open Action Items 736, Promotion Code 740, Contact Source 744, Line of Business 746, number of Employees 750 and Sales Volume 754 of the business (shown in FIG. 20).

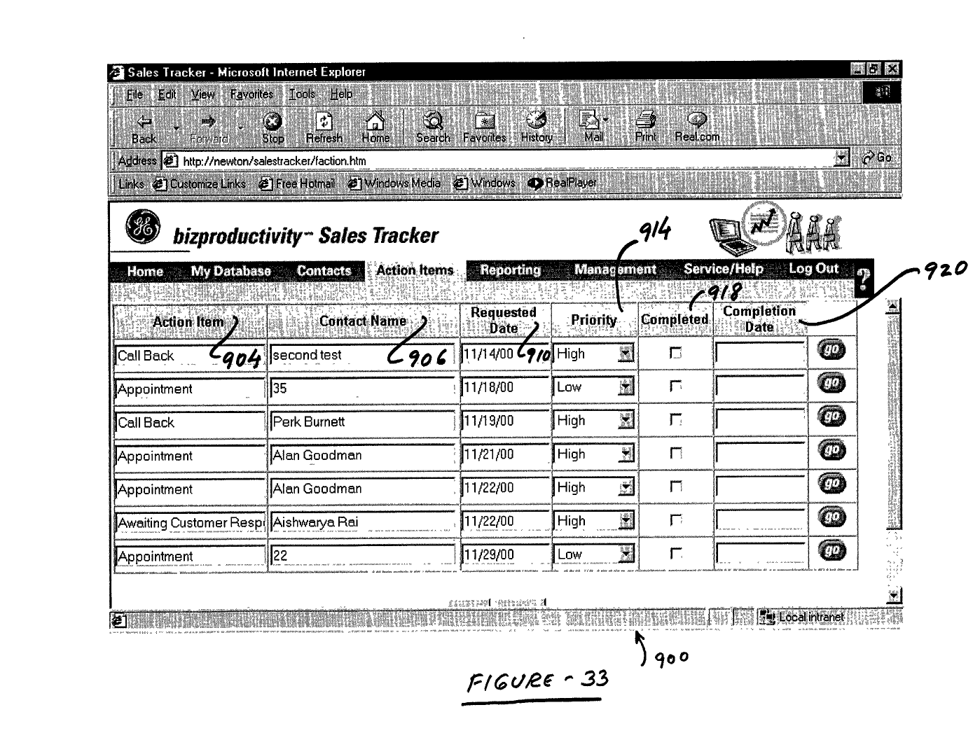

FIG. 33 is an exemplary embodiment of an “Action Items” user interface 900 providing the user with an ability to view an aggregate list of all actions for all contacts that have not been archived. Action Items user interface 900 downloads and displays only open action items in ascending date order. Action Items user interface 900 displays a list of action items 904, contact names associated with each action items 906, requested date 910, priority associated with each action item 914, a completed check box 918 to indicate whether the action item is completed or not, and a completion date 920. Selecting column headings sorts the list.

Priority associated with each action item 914 can be changed via pull downs menus. Completed check box 918 column is set up so that a user can check the box to indicate completion. If the user checks the completed box, completion date 920 is filled in with that day's date and the user is taken to that field in case the user wants to change completion date 920. Selecting individual Action Items 904 allows the user to go to that specific Contact and Action Item page.

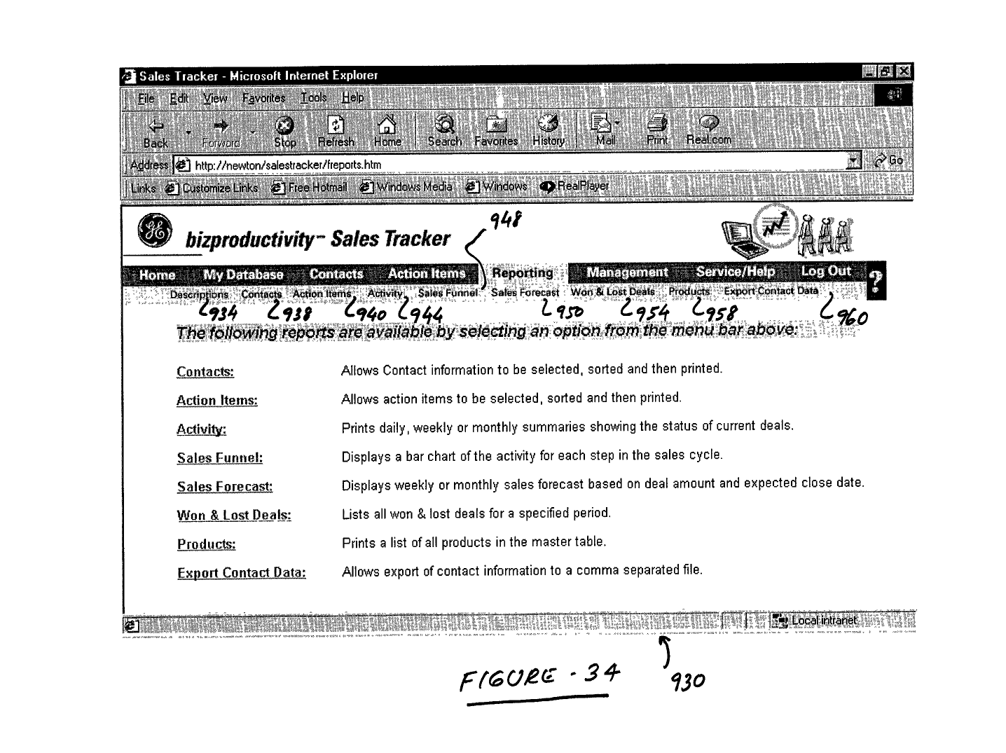

FIG. 34 is an exemplary embodiment of a “Reporting” user interface 930 providing the user with an ability to view various reports. Reporting user interface 930 provides user with an option to view or access various reports stored in database 20. In an exemplary embodiment, Reporting user interface 930 displays several sub-sections of “Reporting”. Reporting user interface 930 section provides the user with an option to view many different reports including, but not limited to, Descriptions 934, Contacts 938, Action Items 940, Activity 944, Sales Funnel 948, Sales Forecast 950, Won & Lost Deals 954, Products 958, and Export Contact Data 960. The user may access each of these sub-sections by selecting a specific subsection button located at the top portion of the user interface.

In an exemplary embodiment, Descriptions 934 report (not shown) is a static HTML page which provides a brief description for each report.

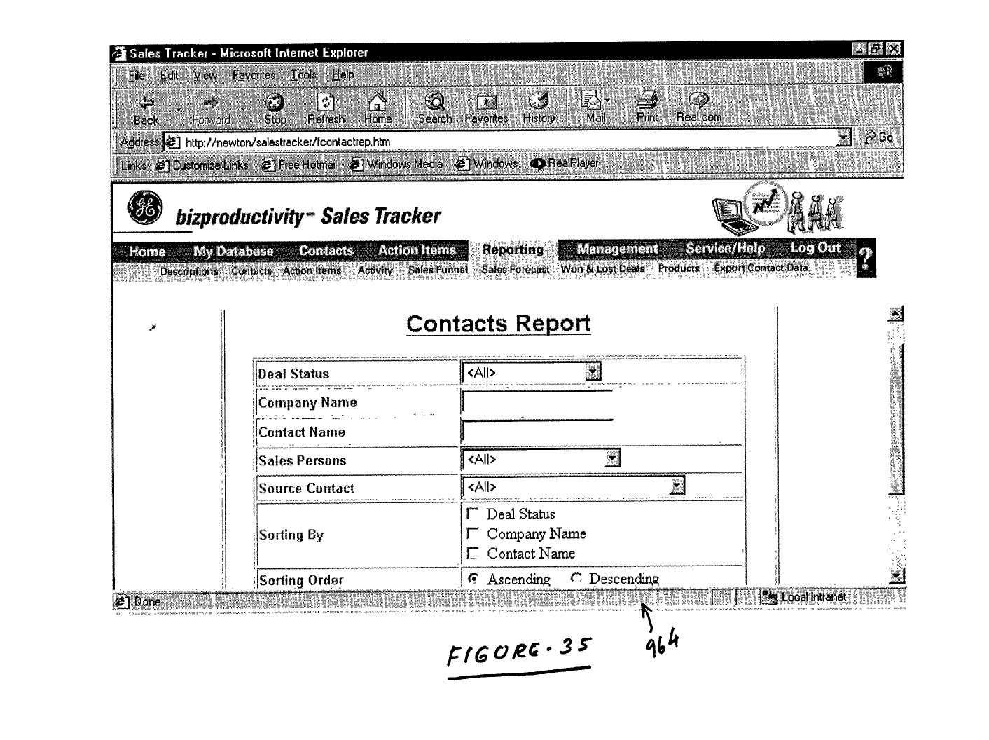

FIG. 35 is an exemplary embodiment of a Contacts Report 964. Contacts report 964 is downloaded and displayed when the user has selected Contacts 938 option (shown in FIG. 34). In an exemplary embodiment, Contacts Report 964 displays the following pull downs at the top of the screen, allowing the user to choose the criteria by which to define the report. For ‘list’, the entire list of available data for that field should be displayed, with the list being narrowed when a selection is made. For example, if Deal Status Qualified is selected, the list under Source would automatically be narrowed so that only those Sources for contacts with a deal status of Qualified would be listed for the user to then narrow the search criteria. Contact Name and Company Name are text boxes that a user can enter a wildcard or specific search entry in. If the user leaves these fields blank, the system assumes all in conducting the search. Deal Status, Sales Person or Source are list pull down boxes where the first entry is “All”, and the appropriate list is displayed. The Sales Person option is not available if the user is a sales person. The user is also allowed to select the Sort Order of the fields that will be displayed on the report by allowing them to Sort By any two of the fields, offering either ascending or descending order. The items that are displayed in the report are the Company Name, Contact Name, Phone Number, Deal Status, Salesperson, and Last Update.

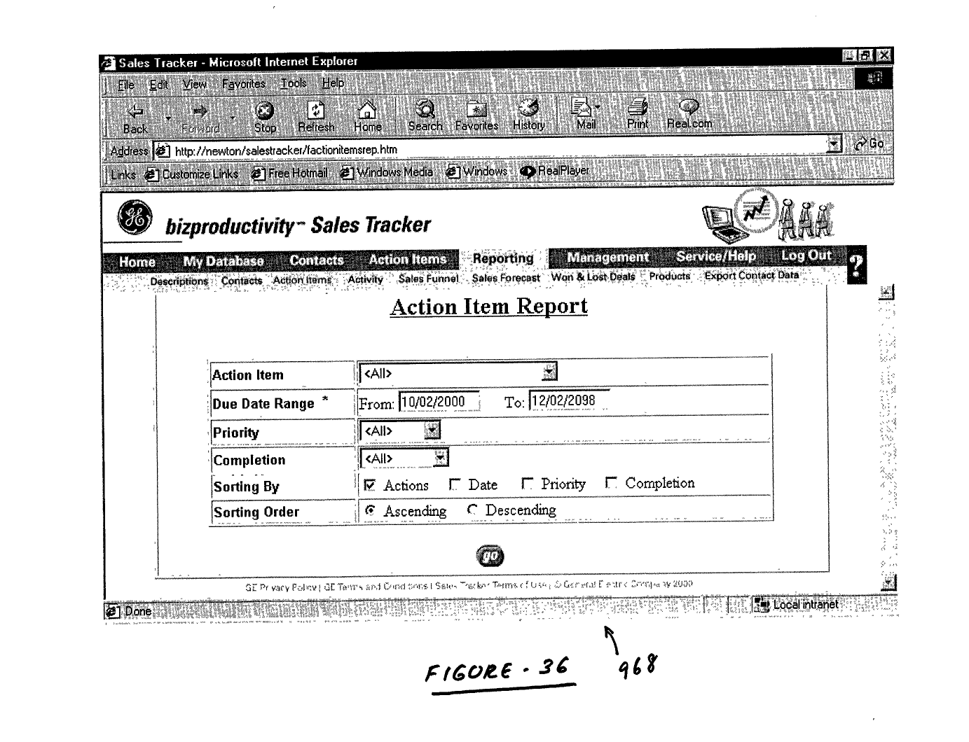

FIG. 36 is an exemplary embodiment of an Action Items Report 968. Action Items Report 968 is downloaded and displayed when the user has selected Action Items 940 option (shown in FIG. 34). In an exemplary embodiment, Action Items Report 968 allows the user to select the data to be displayed by displaying the following fields as pull downs: Action Item, Due Date Range, Priority and Completion. Each of the fields allows the user to select “All” or an item from the list. The Due Date Range is a start and end date for the selection which will correspond to the Requested Date field on the Action Items page. The user is allowed to sort the report by any two of the fields on the report, allowing for an ascending or a descending sort.

In an exemplary embodiment, Activity 944 (shown in FIG. 34) report (not shown) shows the activity for each step in the sales cycle, comparing it against the previous weeks or months. The user is allowed to select the reporting period and interval. Activity 944 report displays the columns for each reporting interval (either daily, weekly or monthly) that shows the number of contacts that were in that deal status during that time period (information that should be stored in the deal status history).

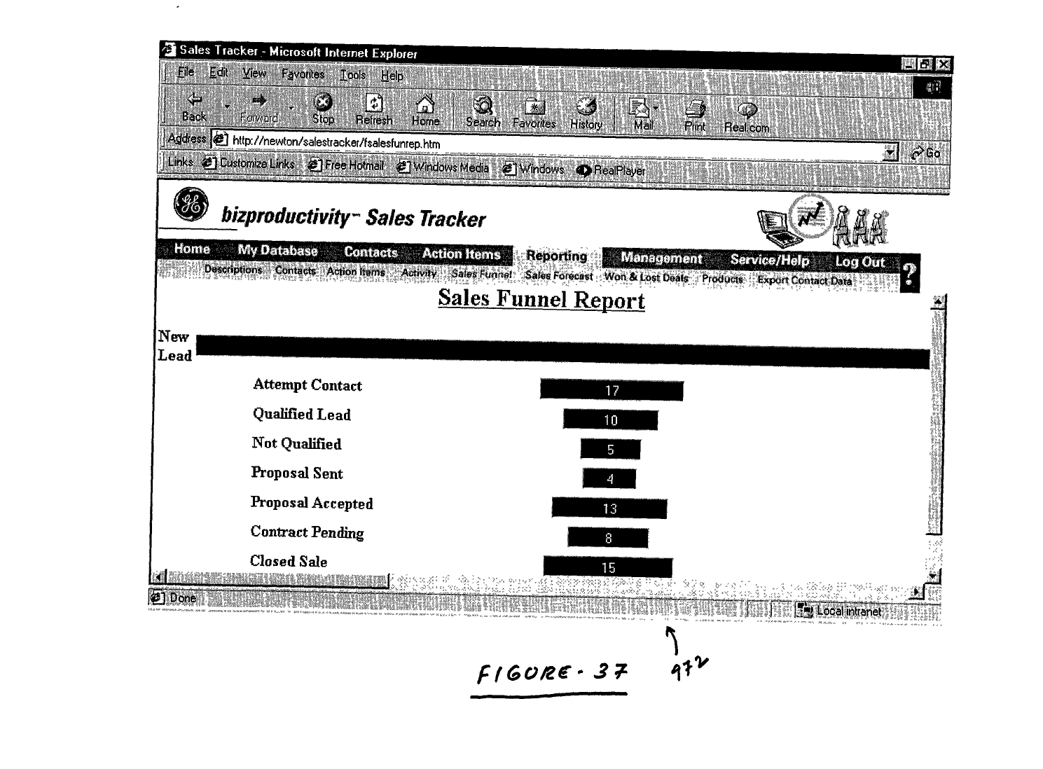

FIG. 37 is an exemplary embodiment of a Sales Funnel Report 972. Sales Funnel Report 972 is downloaded and displayed when the user has selected Sales Funnel 948 option (shown in FIG. 34). In an exemplary embodiment, Sales Funnel Report 972 is a graphical representation of the Sales Cycle or Funnel as it relates to the deal status for all the contacts. Sales Funnel 948 report lists each deal status and then display a bar corresponding to the number of contacts that are currently in that deal status. This does not include the deal status Loss. Sales Funnel 948 report is sorted starting with New Leads and ending with Closed Sale in this order: New Lead, Attempt Contact, Qualified Lead, Not Qualified, Proposal Sent, Proposal Accepted, Contract Pending, Closed Sale.

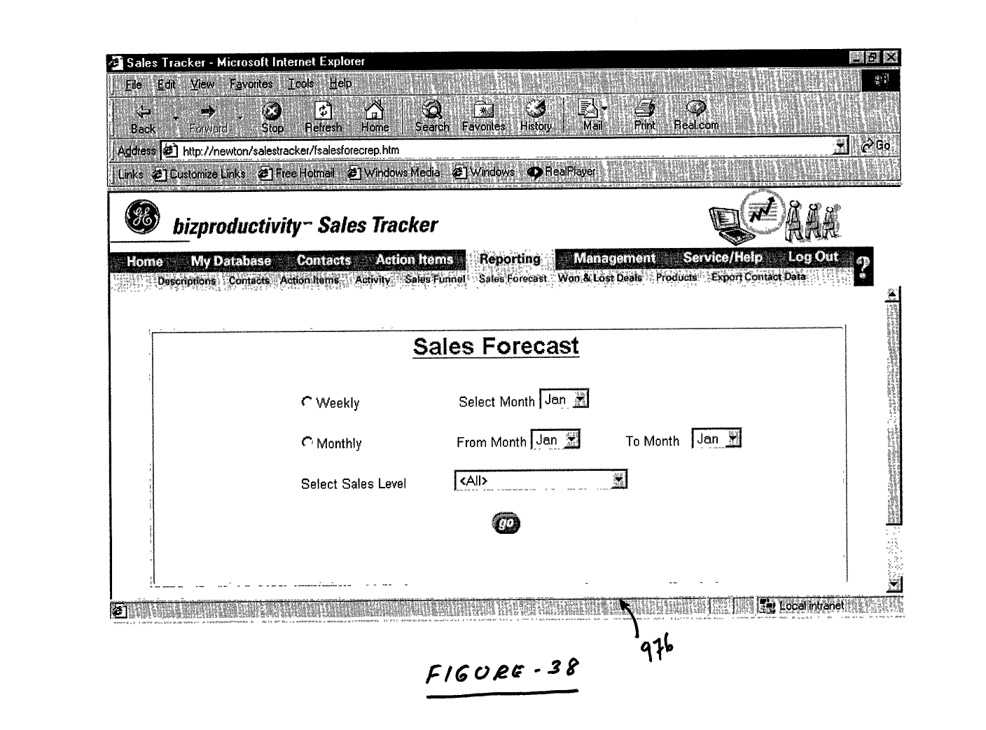

FIG. 38 is an exemplary embodiment of a Sales Forecast Report 976. Sales Forecast Report 976 is downloaded and displayed when the user has selected Sales Forecast 950 option (shown in FIG. 34). In an exemplary embodiment, Sales Forecast Report 976 is a monthly sales forecast based on Deal Amount and Expected Close Date. The user is allowed to choose the reporting period. If the user is not a salesperson but is a level 2 or level 3 manager, the user is allowed to select from a list showing a listing of salespersons and territories. The user is allowed to select the reporting interval of Months or Weeks. The matrix displays row titles showing Territories/Salespersons if the user is not a salesperson, or shows contacts if the user is a salesperson. The column titles will correspond to the reporting intervals: Months or Weeks.

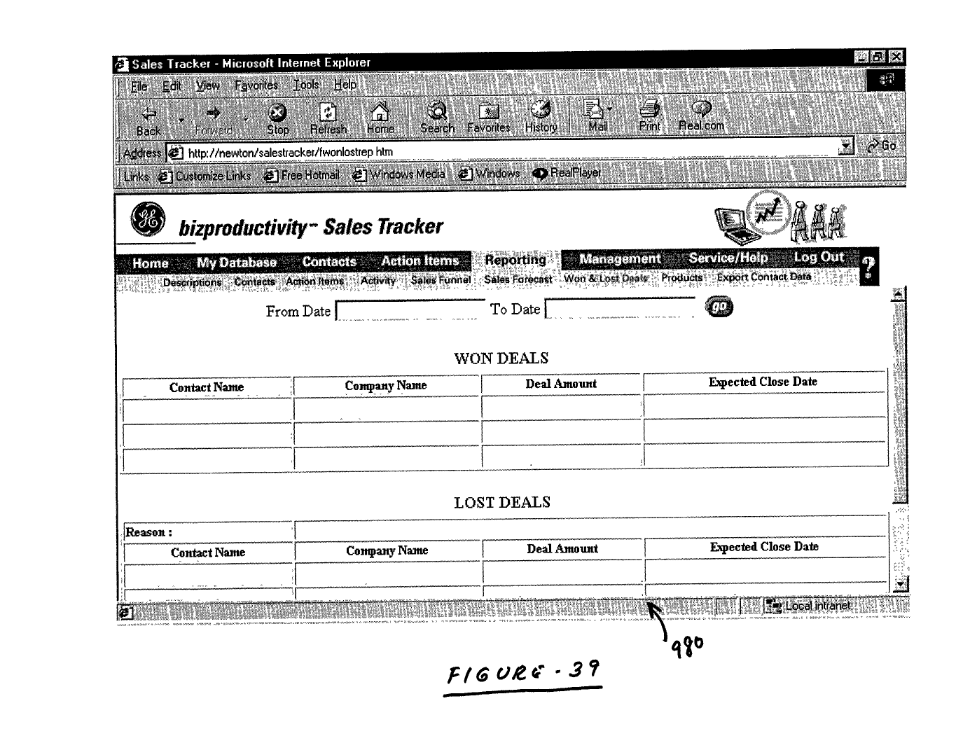

FIG. 39 is an exemplary embodiment of a Won & Lost Deals Report 980. Won & Lost Deals Report 980 is downloaded and displayed when the user has selected Won & Lost Deals 950 option (shown in FIG. 34). In an exemplary embodiment, Won & Lost Deals Report 980 displays all the contacts that have a deal status of Loss or Sale Closed during a user-specified interval. Starting with those that were won, it lists a Contact Name, a Company Name, a Deal Amount and an Expected Close Date. For all Lost Deals it lists, under each Reason Code, it also lists a Contact Name, a Company Name, a Deal Amount and an Expected Close Date. The user is prompted to enter the starting and ending dates for the report.

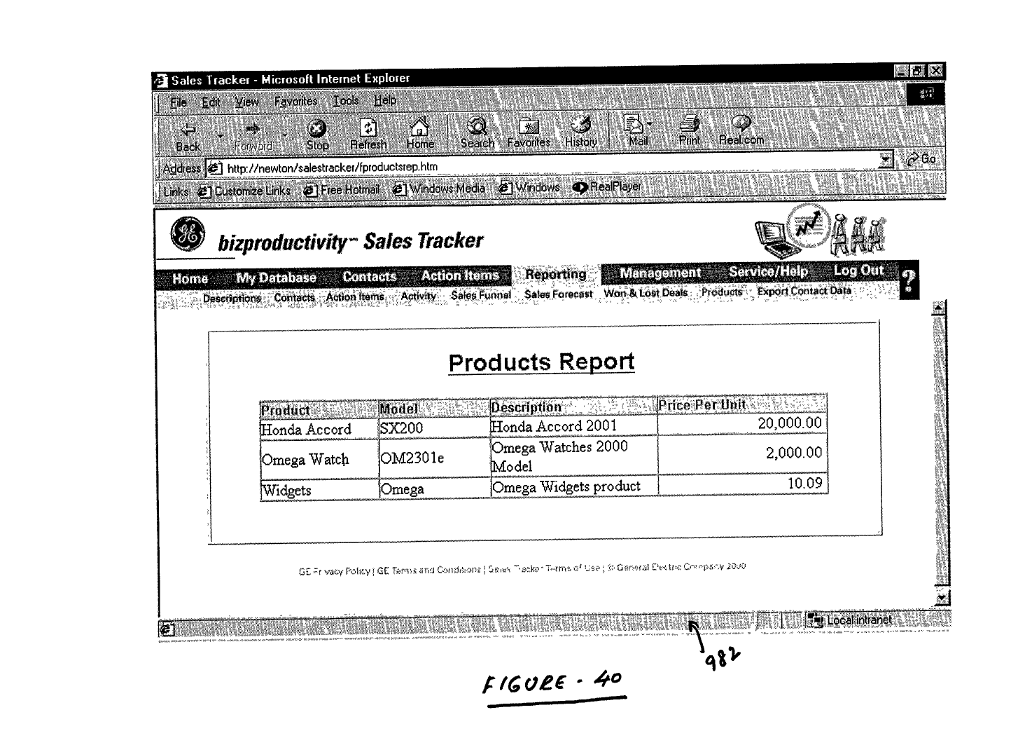

FIG. 40 is an exemplary embodiment of a Products Report 982. Products Report 982 is downloaded and displayed when the user has selected Products 950 option (shown in FIG. 34). In an exemplary embodiment, Products Report 982 shows a listing of all the Products that were entered via the Management—Update Product Table page, displaying the same fields that are currently available on that page: Product, Model, Description, and Price Per Unit.

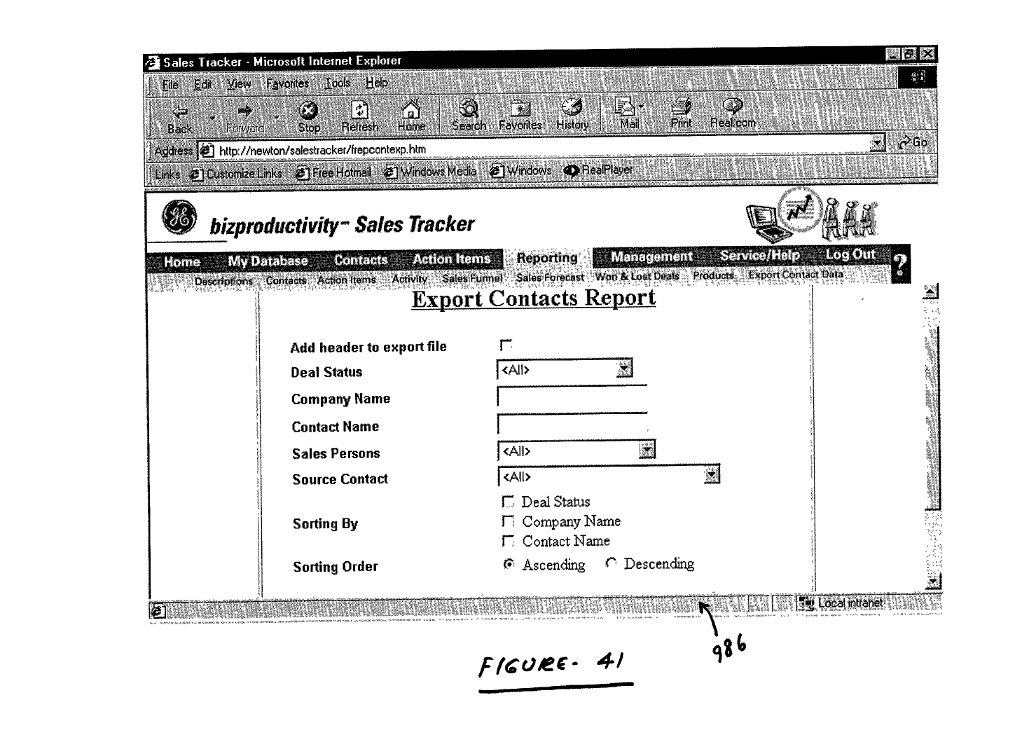

FIG. 41 is an exemplary embodiment of an Export Contacts Report 986. Export Contacts Report 986 is downloaded and displayed when the user has selected Export Contacts 950 option (shown in FIG. 34). In an exemplary embodiment, Export Contact Data Report 950 allows the user to export contact information to a comma separated file. Export Contact Data Report 986 has the same selection criteria as the Contacts Report, but outputs every field that is currently displayed on the Contacts Add page. In an exemplary embodiment, the criteria selection page also has a checkbox for the user to indicate if the file should have a header record (not shown).

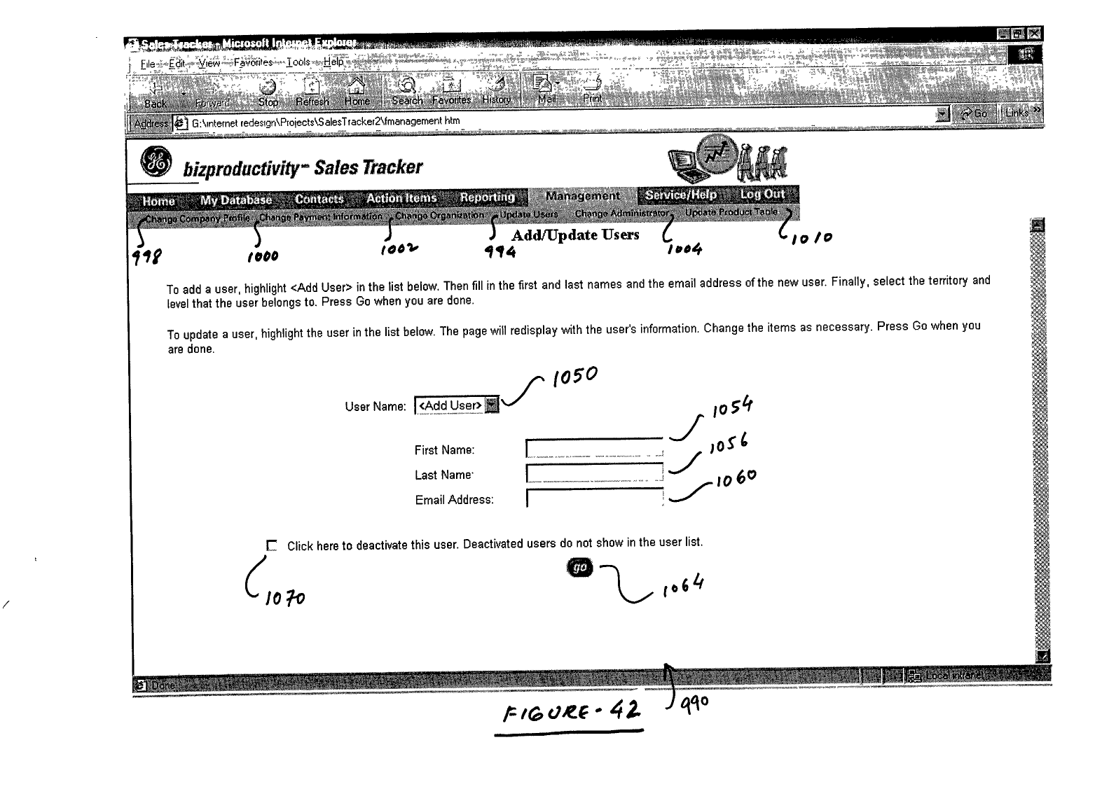

FIGS. 42 through 51 are exemplary embodiments of various subsections of “Management” 400 (shown in FIG. 16).

For example, FIG. 42 is an exemplary embodiment of an “Add/Update Users” user interface 990 providing the user with an ability to perform several management functions based on the information stored in database 20. Add/Update Users user interface 990 is one of a sub-section of “Management” 400 (shown in FIG. 16). “Management” 400 section provides the user with an option to perform many different functions including, but not limited to, Add/Update Users 994, Change Company Profile 998, Change Payment Information 1000, Change Organization 1002, Change Administrator 1004, and Update Product Table 1010. The user may access each of these sub-sections by selecting that specific sub-section button located at the top portion of the user interface.

Add/Update Users user interface 990 function is not available for the “individual” Sales Tracker customer. Add/Update Users user interface 990 allows the user to add or update users. Any updates made here are reflected in the system web users table using the Customer Center Oracle function(s).

A list box 1050 is displayed with <Add User> as the first selection and the list of users following. If Add User is selected, the user enters a first name 1054, a last name 1056, and an e-mail address 1060 and then selects “Go” button 1064. Once the action is complete the same user is displayed.

If a username is selected, the user is allowed to fill in the information for that specific user and allowed to change it, or deactivate the user by selecting the deactivate user check box 1070. Once the user is done, the user selects “Go” button 1064 to complete the process. Once complete, the same user is displayed, unless the user has been deactivated in which case the fields are empty and “Add User” is highlighted.

After a user is added, the system administrator sends an e-mail to both the managers and administrators, giving them the username and password for the new user(s).

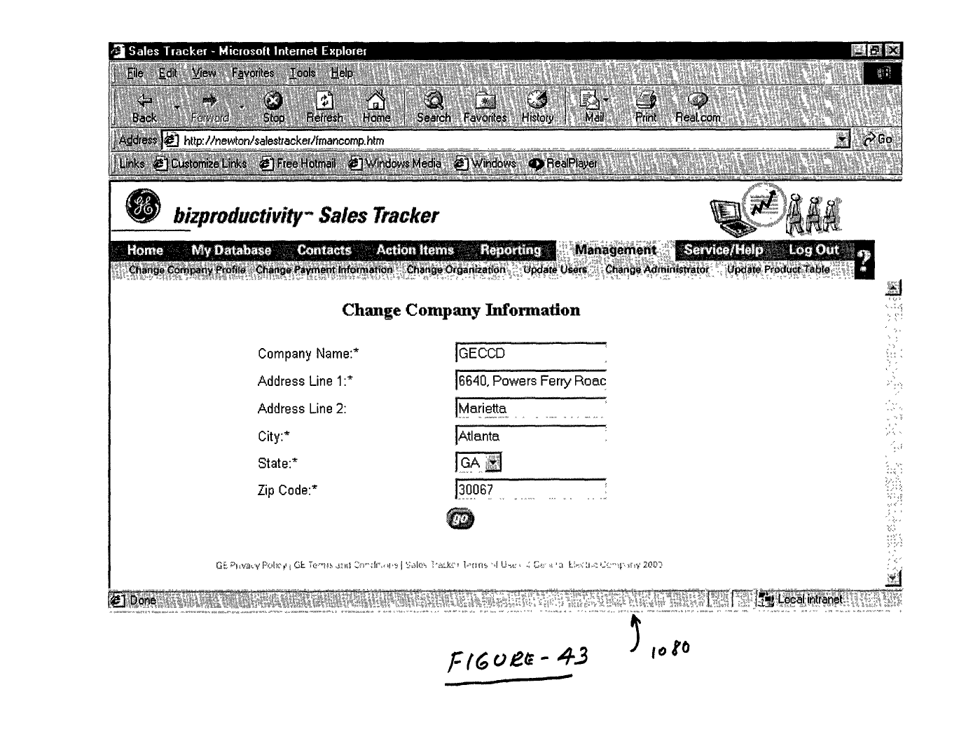

FIG. 43 is an exemplary embodiment of a “Change Company Profile” user interface 1080 providing the user with an ability to change a company profile stored in database 20. Change Company Profile user interface 1080 displays the current information about the company and allows the user to change it.

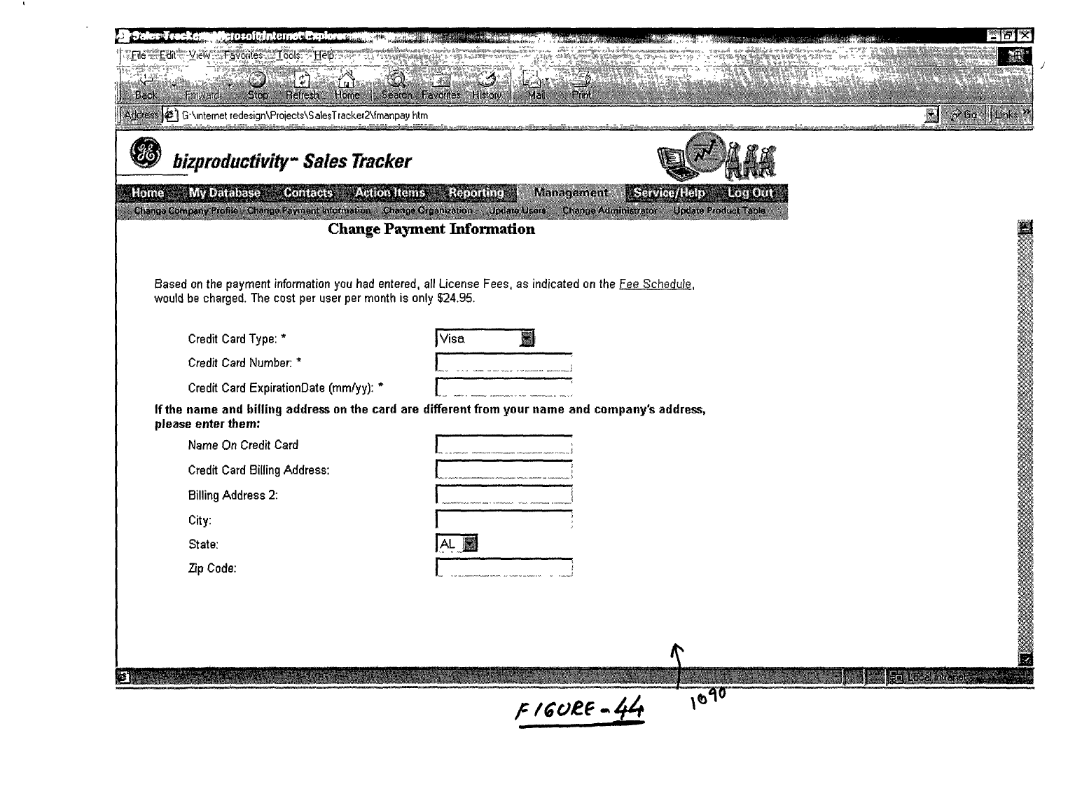

FIG. 44 is an exemplary embodiment of a “Change Payment Information” user interface 1090 providing the user with an ability to change payment information stored in database 20. Change Payment Information user interface 1090 allows the user to change the payment information. The credit card field needs to be validated.

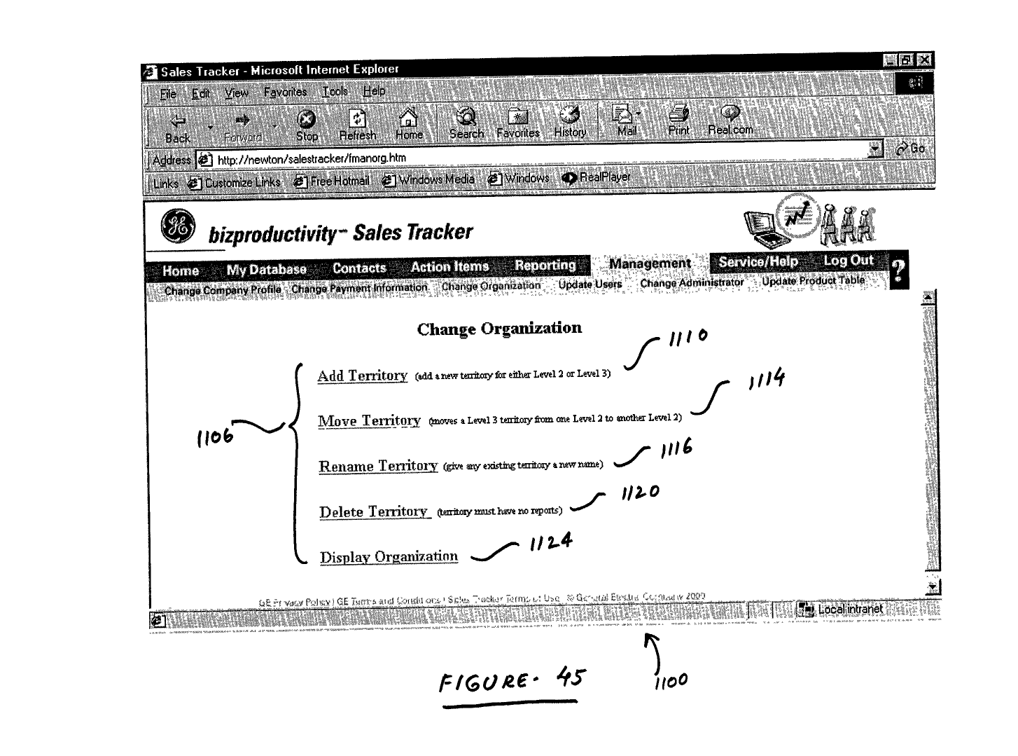

FIG. 45 is an exemplary embodiment of a “Change Organization” user interface 1100 providing the user with an ability to change organizational information stored in database 20. Change Organization user interface 1100 allows the user to change the organizational structure that was defined when the user completed the enrollment section. Change Organization user interface 1100 displays a menu of several hypertext links 1106 providing the following options: Add Territory 1110, Move Territory 1114, Rename Territory 1116, Delete Territory 1120, and Display Organization 1124. Change Organization user interface 1100 is also referred to as a menu page.

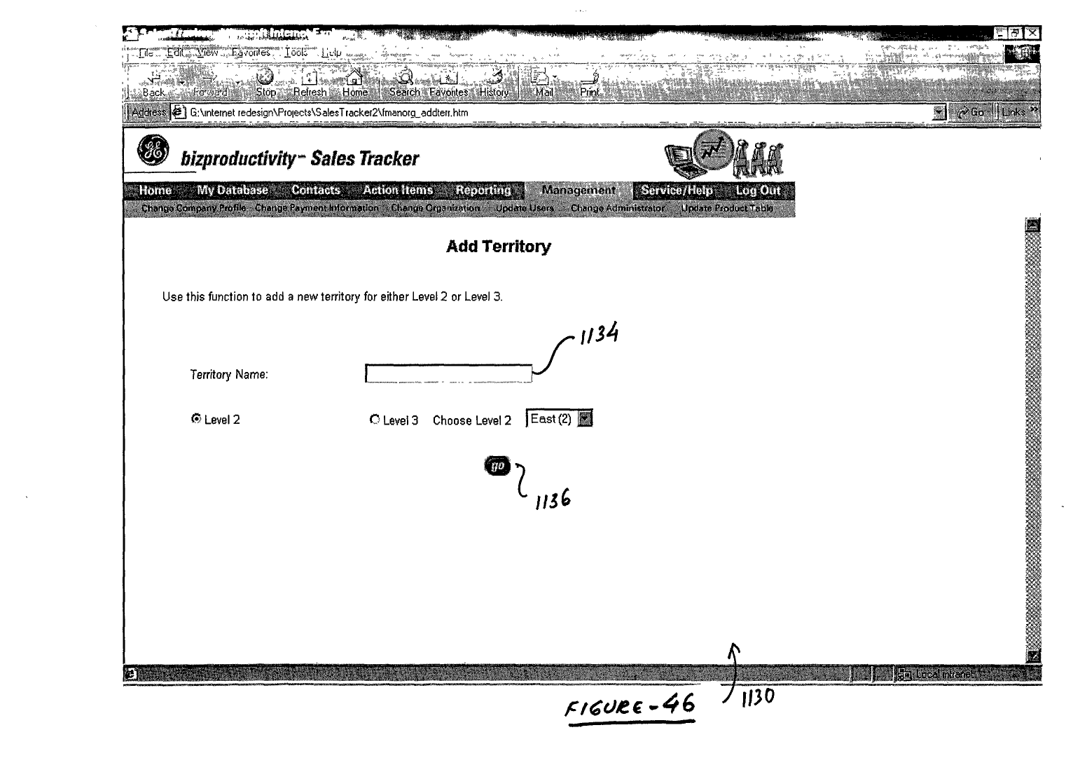

FIGS. 46 through 49 are exemplary embodiments of user interfaces relating to various displayed menu 1106 (shown in FIG. 45) options on Change Organization user interface 1100 (shown in FIG. 45).

FIG. 46 is an exemplary embodiment of an “Add Territory” user interface 1130. Add Territory user interface 1130 allows the user to add a territory by typing in a territory name 1134 and then selecting a “Go” button 1136 to indicate whether it is a level 2 or 3. If it is a level 3, the user is asked to select the level 2 that this territory reports to. Once the user has done so, the user selects Go button 1136 which returns the user back to the menu page 1100 (shown in FIG. 45).

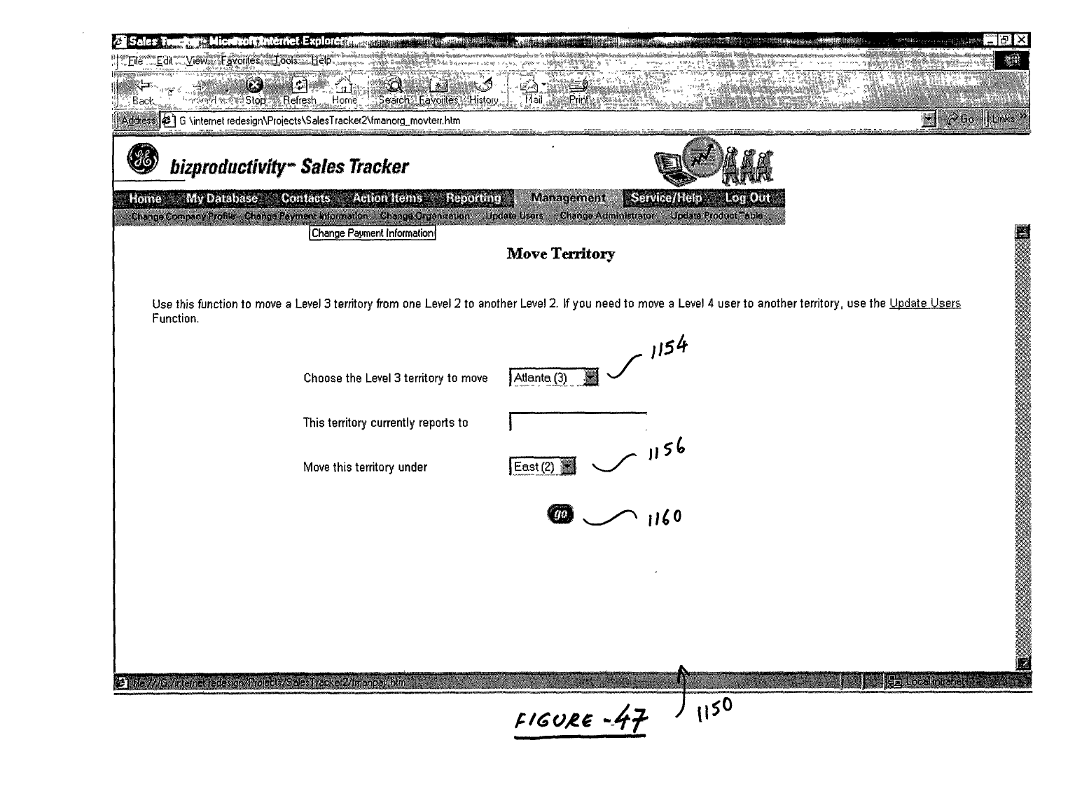

FIG. 47 is an exemplary embodiment of a “Move Territory” user interface 1150. Move Territory user interface 1150 allows the user to move a territory. The user would choose a level 3 territory 1154 the user wishes to move and a level 2 territory 1156 to move it under. In both cases the user would be presented with list boxes from which the user can choose a territory. Once the user is done, the user selects a “Go” button 1160 which returns the user back to menu page 1100 (shown in FIG. 45).

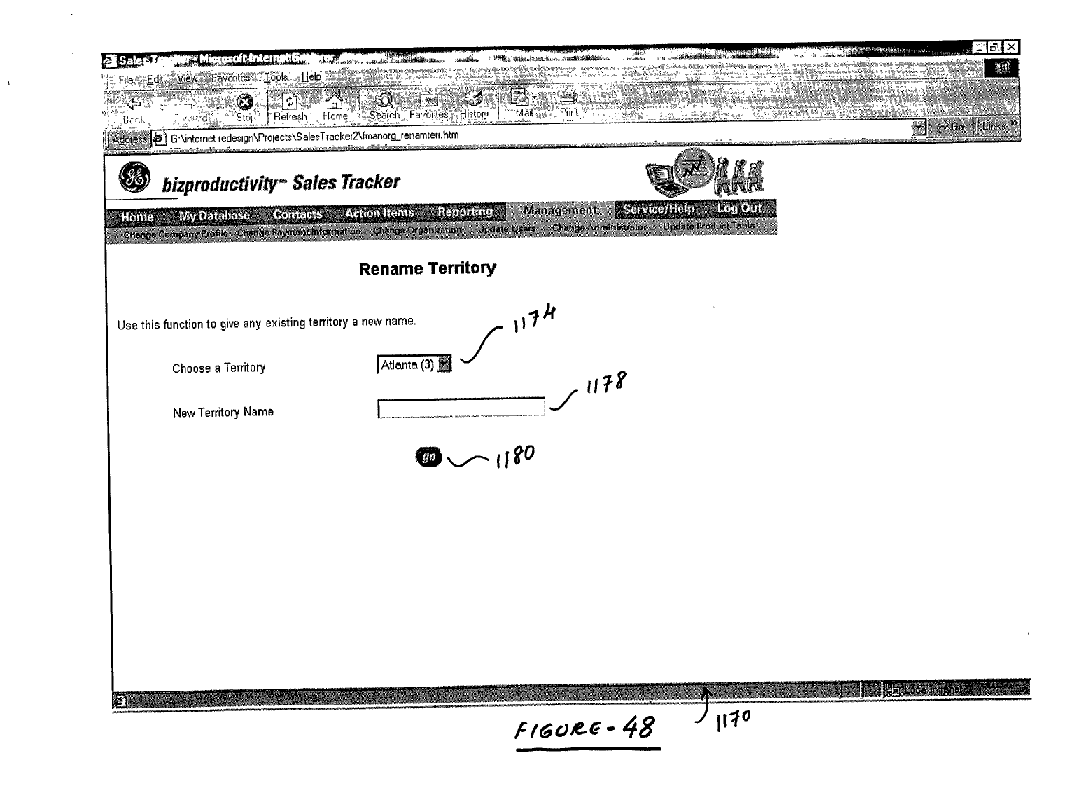

FIG. 48 is an exemplary embodiment of a “Rename Territory” user interface 1170. Through Rename Territory user interface 1170, the user is allowed to choose a territory from a drop down list box 1174 that the user wishes to rename and then allowed to enter in the new territory name 1178. Selecting a Go button 1180 completes the renaming process and returns the user back to menu page 1100 (shown in FIG. 45).

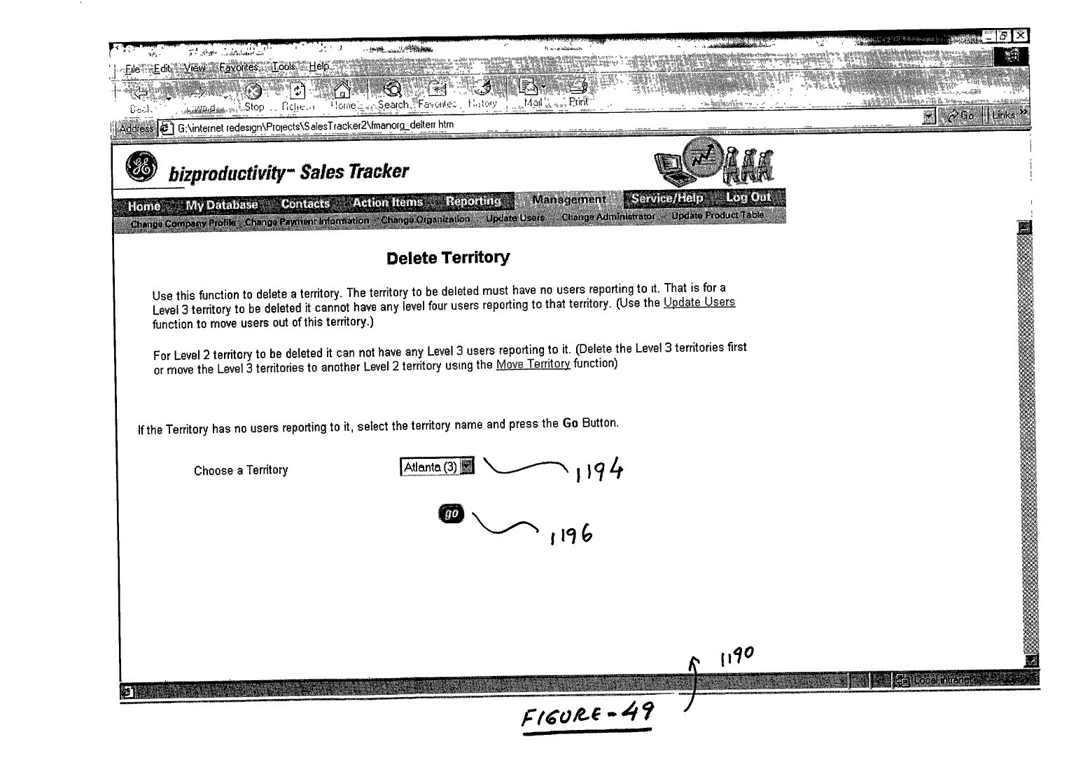

FIG. 49 is an exemplary embodiment of a “Delete Territory” user interface 1190. Through Delete Territory user interface 1190, the user is allowed to delete a territory that has no reporting users or territories. The user is presented with a drop down list box 1194 of all level 2 and 3 territories and allowed to choose the territory the user wishes to delete. When a “Go” button 1196 is clicked, a confirmation box is displayed for the user. If an error occurs (such as having reporting users or territories) an appropriate message is displayed in a pop-up box and the user remains on this page. Otherwise, once the user has successfully completed the process by selecting Go button 1196, the user is returned to menu page 1100 (shown in FIG. 45).

In an exemplary embodiment (not shown), the system also provides an ability to Display Organization that currently exists in database 20. This is the same as the enrollment verification functionality. The organization chart image is on the right side of the page. This is a display only view. It contains links to all of the other links in this function.

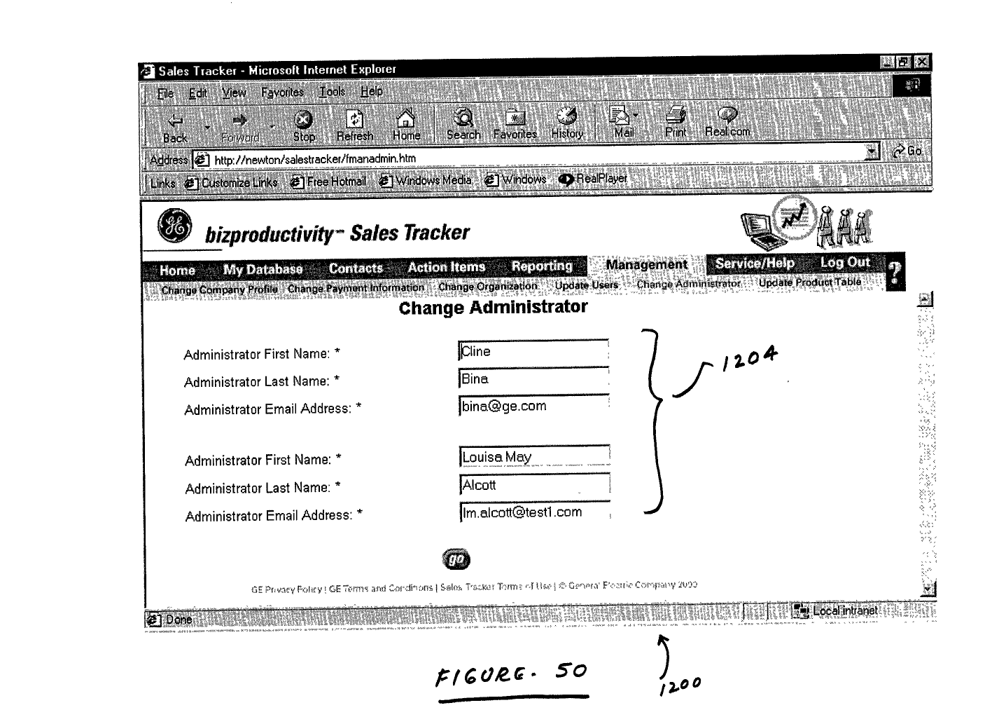

FIG. 50 is an exemplary embodiment of a “Change Administrator” user interface 1200 providing the user with an ability to change administrator information stored in database 20. Change Administrator user interface 1200 allows System 10 two individuals to be administrators, the enrollee and the person designated as the administrator. Information 1204 about these individuals is displayed on user interface 1200 and can be updated. If a user is completely changed, a message is displayed indicating that the old user will be deactivated as an administrator.

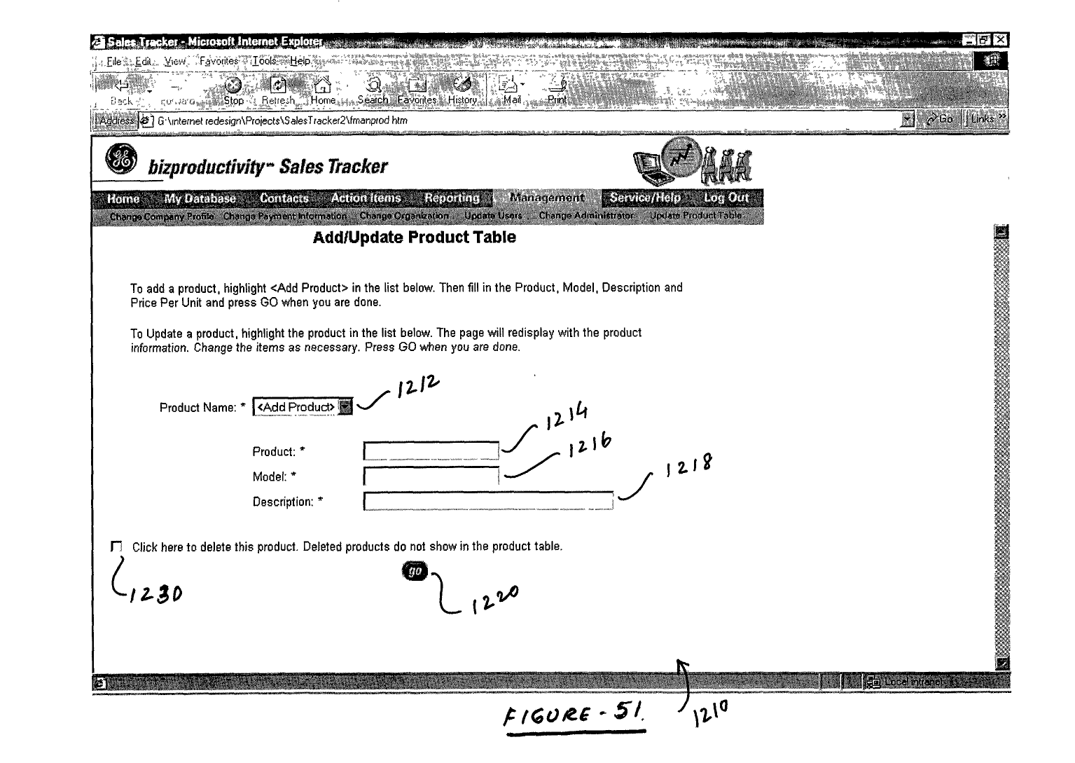

FIG. 51 is an exemplary embodiment of an “Add/Update Product Table” user interface 1210 providing the user with an ability to Add/Update Product Table information stored in database 20. Add/Update Product Table user interface 1210 allows the user to add or update the product table. A list box 1212 is displayed with <Add Product> as the first selection and the list of products following. If Add Product is selected, the user enters the information such as a name of a product 1214, a model number 1216, and description 1218 of the product and then selects a “Go” button 1220. Once the action is complete, the same product is displayed.

If a product is selected, the user is allowed to fill in the information for that product and then allowed to change it, or to delete that product by checking a delete product check box 1230. Once the user is done, the user selects Go button 1220. Once complete, the same product is displayed, unless the product was deactivated in which case the fields are empty and Add Product is highlighted.

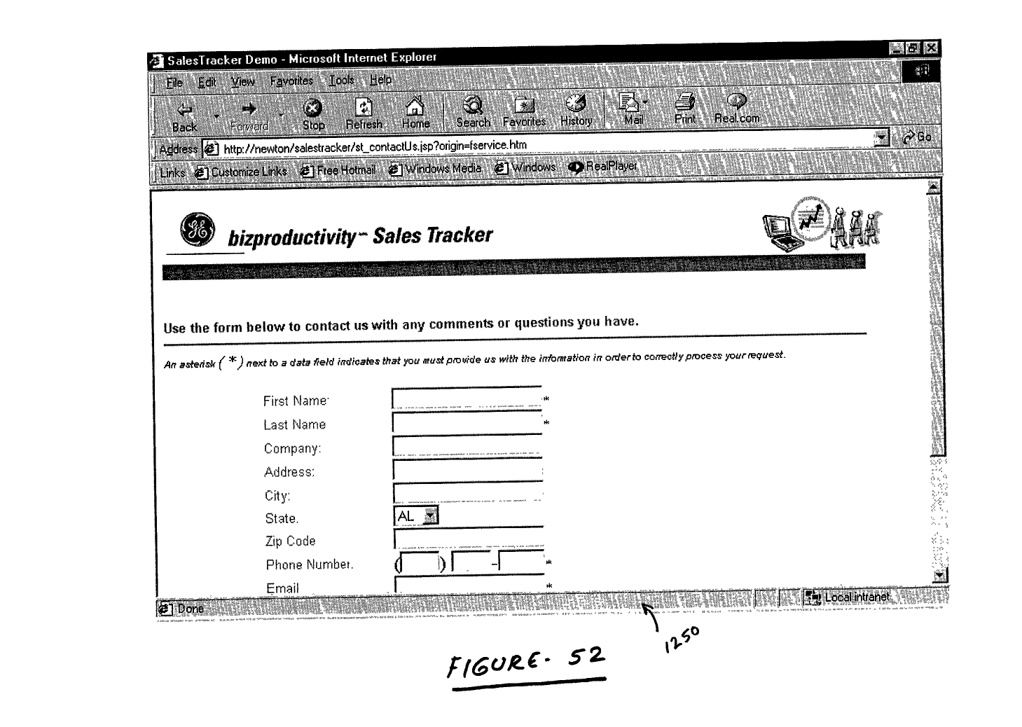

FIG. 52 is an exemplary embodiment of a “Contact Us” user interface 1250. Through Contacts Us user interface 1250, the user is allowed to provide comments or questions related to the product. Once the user provides the requested information to help facilitate processing the Comments/Questions, the user submits the information by selecting a Go button (not shown).

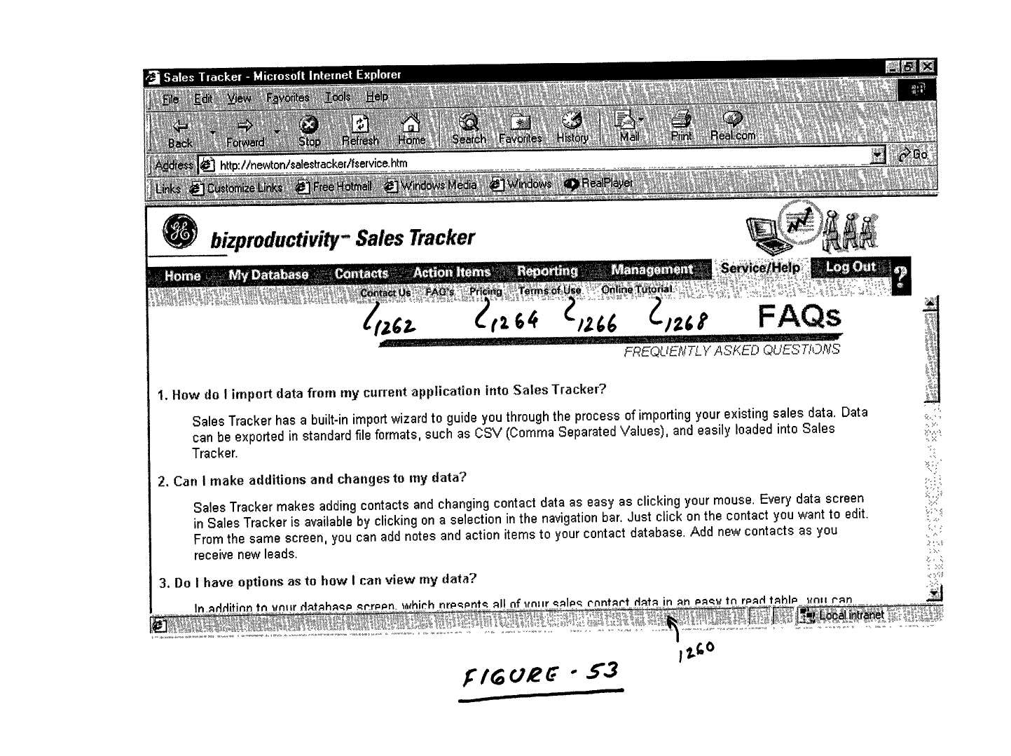

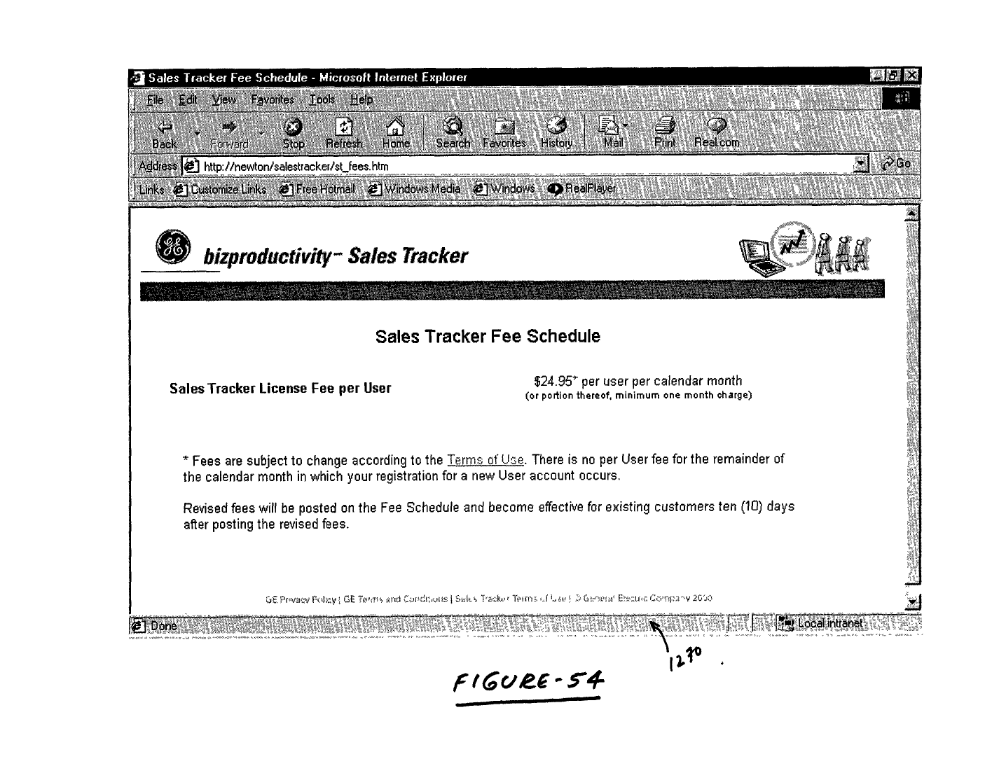

FIG. 53 is an exemplary embodiment of a “Frequently Asked Questions” user interface 1260. Through Frequently Asked Questions user interface 1260, the user accesses the response to several important questions regarding the utility of the web-based application. Frequently Asked Questions user interface 1260 is a sub-section of Service/Help 410 section (shown in FIG. 16). Other sub-sections of Service/Help 410 section includes, Contact Us 1262, Pricing 1264, Terms of Use 1266, and an Online Tutorial 1268. Selecting individual sub-sections and double clicking the same, server system 12 (shown in FIG. 1) downloads and displays related user interfaces. For example, server system 12 downloads and displays Contacts Us user interface 1250 (shown in FIG. 52) when the user selects and double clicks Contact Us 1262. Similarly Pricing User Interface 1270 (shown in FIG. 54) is downloaded and displayed when the user selects and double clicks Pricing 1264. The user also has an option to access online tutorial by selecting and double clicking “Online Tutorial”. The screens relating to online tutorial are shown in Appendix B. The tutorial shows the user just how easy it is to use the Sales Tracker/System for Managing Sales Deals to enhance the sales productivity. It provides the user with a step by step approach in utilizing the system and resolving user related issues.

FIG. 54 is an exemplary embodiment of a “Pricing” user interface 1270. Through Pricing user interface 1270, the user is provided the pricing plan or a fee schedule.

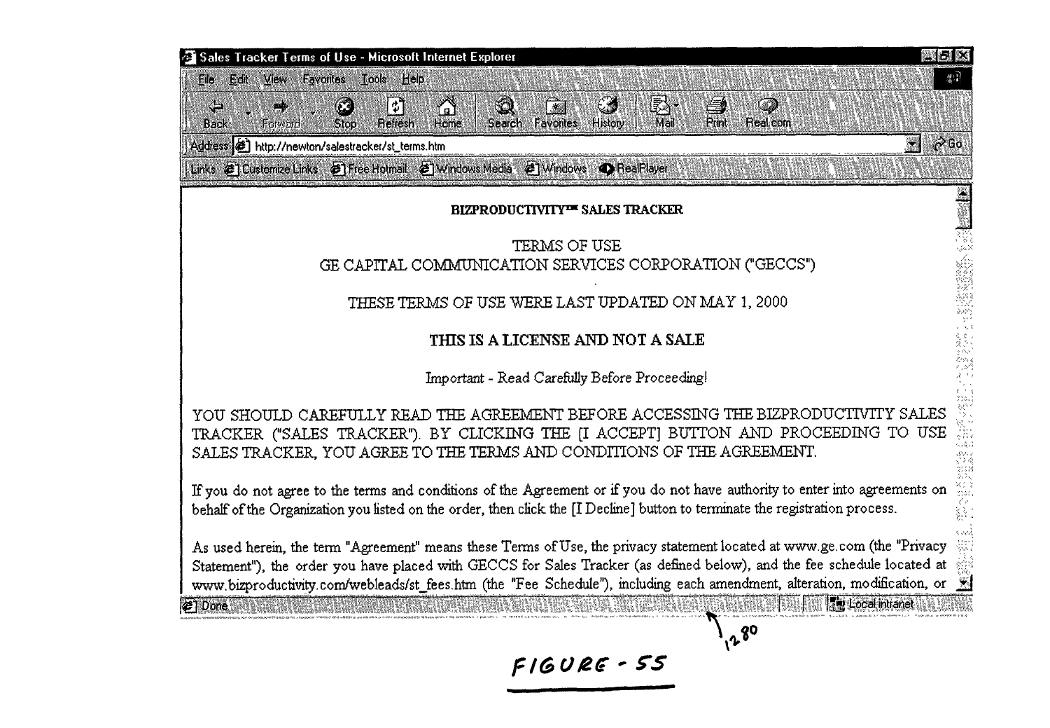

FIG. 55 is an exemplary embodiment of a “Terms of Use” user interface 1280. Through Terms of Use user interface 1250, the user is provided the terms and conditions under which the user is permitted to use the system and the associated software. Terms of Use user interface 1280 is downloaded and displayed when the user selects and double clicks Terms of User 1266 (shown in FIG. 53). Terms of user may also be downloaded and displayed when the user selects and double clicks “Terms of Use” hypertext link shown under Pricing user interface 1270 (shown in FIG. 54).

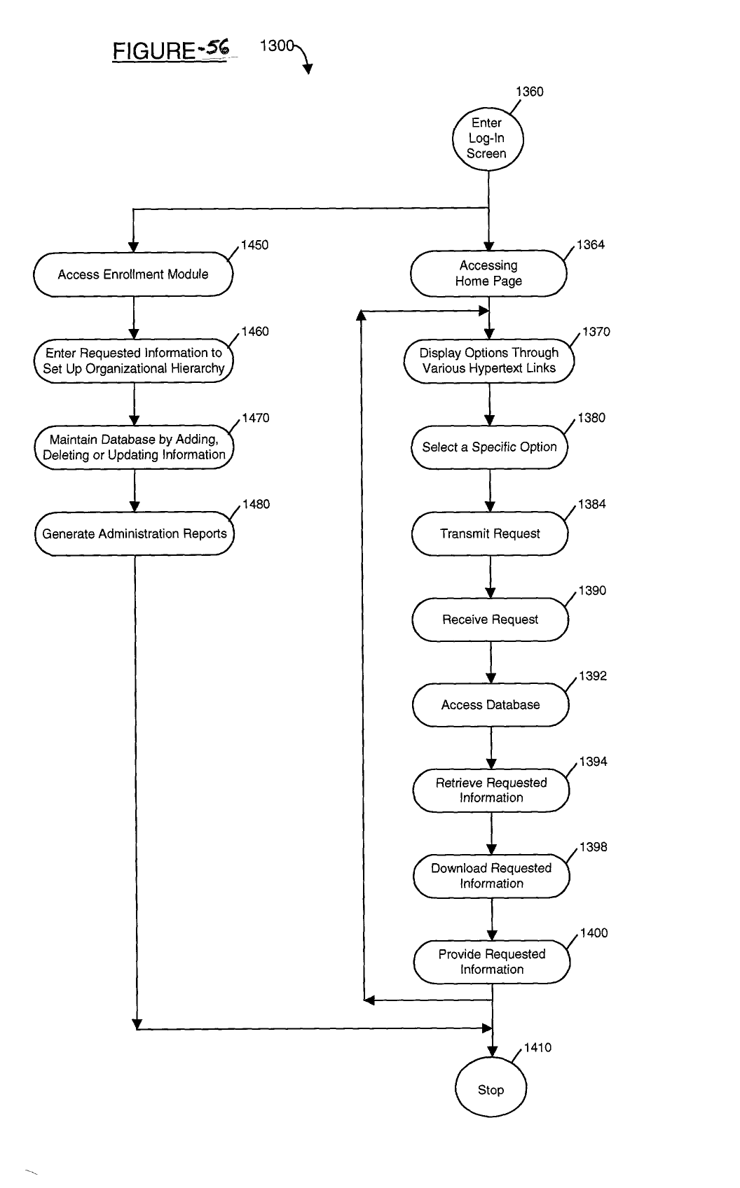

FIG. 56 is an algorithm 1300 practiced utilizing SLMS 10. In an exemplary embodiment, the user enters the log-in screen 1360 and through the log-in screen, accesses 1364 home page 330 (shown in FIG. 16) of the web site through client system 14 (shown in FIG. 1). Home page 330 displays several options 1370. Once the user selects 1380 a specific option from the various hypertext links, the request is transmitted to server system 12. Transmitting the request 1384 is accomplished either by the click of a mouse or by a voice command. After the request is received 1390, server system 12 accesses 1392 database server 16 and retrieves 1394 related information from database 20 (shown in FIG. 1). The requested information is downloaded 1398 and provided 1400 to client system 14 from server 12. The user continues to search database 20 for other information or exits 1410 from SLMS 10.

In another embodiment, the user enters the log-in screen 1300 and through the log-in screen, and accesses 1450 enrollment module to complete the enrollment process to use SLMS 10. The user enters 1460 the requested information to set up an organizational hierarchy. Throughout the process of providing the information, the user is prompted through pull down menus or other blank fields displayed on the user interface. The user may also maintain 1470 the database by adding, deleting or updating information to ensure the accuracy of organizational hierarchy or other related information. The user may generate 1480 a variety of management reports or simply exit 1410 the system.

In one embodiment, client system 14, as well as server system 12, are protected from access by unauthorized individuals. As described, SLMS 10 includes an interactive searchable database 20 for all leads related information which provides flexibility to sales representatives as well as management staff to maintain leads tracking records to date and stay current with the status of all leads. Through SLMS 10, managers, sales representatives (including employees, contractors and variable workers) and database administrators directly update, review and generate reports of current information.

While the invention has been described in terms of various specific embodiments, those skilled in the art will recognize that the invention can be practiced with modification within the spirit and scope of the claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for tracking deals using a web-based system including a server system coupled to a centralized interactive database and at least one client system, said method comprising the steps of:
receiving deal information into a centralized database;
storing the deal information into various sub-sections of the centralized database and cross-referencing the deal information against a unique identifier for easy retrieval and update; and
retrieving the deal information from the centralized database in response to an inquiry to provide a current status of the deal.

2. A method according to claim 1 wherein said step of receiving deal information further comprises the step of organizing deal information into various sub-sections of the database.

3. A method according to claim 1 wherein said step of receiving deal information further comprises the step of adding at least one of New Contacts, Notes regarding a specific Contact, Action Items with reference to a specific Contact, Products, and Product Tables.

4. A method according to claim 3 wherein said step of adding new contact information further comprises the steps of adding at least one of a Contact Name, a Title, a Company Name, a Company Address including a City Name, a State, and a Zip Code, a Phone Number, a Fax Number, an E- Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business.

5. A method according to claim 1 wherein said step of storing the deal information further comprises the step of updating at least one of a Contact Name, a Title, a Company Name, a Company Address including a City Name, a State, and a Zip Code, a Phone Number, a Fax Number, an E-Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business, Notes, Action Items, Products, Database Sub-Sections, Deal History, Contact Information, various Management reports, and other relevant information about the Deal.

6. A method according to claim 5 wherein said step of updating the deal information further comprises the steps of:
adding and deleting individual records; and
editing the deals and deals related information.

7. A method according to claim 5 wherein said step of updating the deal information into the centralized database further comprises the step of entering the deal information online.

8. A method according to claim 5 wherein said step of updating the deal information further comprises the step of entering information at least through one of a voice activation command and a device connected to the client system.

9. A method according to claim 1 wherein said step of storing the deal information further comprises the steps of:
tracking the deal information on a real time basis; and
storing the deal information on a real time basis by updating stored information by adding the new information to the centralized database on a real time basis to provide up-to-date deal information instantaneously to the user upon a request.

10. A method according to claim 1 wherein said step of retrieving the deal information in response to an inquiry further comprises the steps of:
downloading requested information from a server system; and
displaying at least one of Notes, Action Items, Products, Database Sub-Sections, Deal History, and Contact Information through various management reports on a client system in response to the inquiry.

11. A method according to claim 1 wherein said step of retrieving the deal information further comprises the steps of:
printing requested information in a pre-determined format; and
printing at least one of management report regarding Descriptions, Contacts, Action Items, Activities, Sales Funnel, Sales Forecast, Won and Lost Deals, Products and Exporting Contact Data.

12. A method according to claim 1 wherein said step of retrieving the deal information further comprises the step of providing the deal information to the user.

13. A method according to claim 12 wherein said step of providing the deal information further comprises the steps of:
receiving an inquiry from the client system; and
displaying information on the client system.

14. A method according to claim 13 wherein said step of receiving an inquiry from the client system further includes the step of submitting a request through at least one of pull down menus, check boxes, and hypertext links.

15. The method according to claim 13 wherein said step of displaying information further includes the step of displaying an HTML document downloaded by the server system.

16. A method according to claim 13 wherein said step of displaying further comprises the step of displaying at least one alternative from various alternatives available to the user.

17. A method according to claim 10 wherein said step of downloading the information in response to the inquiry further comprises the steps of:
accessing the centralized database;
searching the database regarding the specific inquiry;
retrieving information from the database; and
transmitting the retrieved information to the client system for display by the client system.

18. A method according to claim 10 wherein said step of downloading further comprises the step of downloading extracted deal information and other relevant data into at least one of a database software and a financial spread sheet software.

19. A method according to claim 1 wherein said step of receiving further comprises the step of receiving data extracts from at least one of a database software and a financial spread sheet software.

20. A method for tracking and managing deals using a web-based system including a server system coupled to a centralized interactive database and at least one client system, said method comprising the steps of:
setting up the user's organizational hierarchy through enrollment process and then:
maintaining database by adding, deleting and updating information;
tracking action items according to assigned priorities;
generating management reports; and
providing flexibility to an administrator to modify user profile information.

21. A method according to claim 20 further comprising the step of providing online help to the user by downloading a user manual on to a client device.

22. A method according to claim 20 wherein said step of setting up the user's organizational hierarchy through enrollment process further comprises the steps of:
providing information about a user, the user's company, number of users planning to utilize the method, a name of an administrator and other related information, and payment information including a credit card number, billing address, credit card type, credit card expiration date; and
providing information about the user's sales organization including sales territories, information about each sales representative and associated sales territory each sales representative is assigned to, and reporting relationship among sales territories.

23. A method according to claim 20 wherein said step of setting up the user's organizational hierarchy through enrollment process further comprises the steps of:
adding another territory;
renaming a territory;
adding another user; and
updating a user.

24. A method according to claim 20 wherein said step of generating management reports further comprises the step of generating at least one of Descriptions Report, Contacts Report, Action Items Report, Activities Report, Sales Funnel Report, Sales Forecast Report, Won and Lost Deals Report, and Products Report.

25. A method according to claim 20 wherein said step of providing flexibility to an administrator further comprises providing option to the administrator which includes at least one of changing company profile option, changing payment information option, changing organization structure option, updating users option, changing administrator option, and updating product table option.

26. A method according to claim 20 wherein said step of maintaining the database by adding, deleting and updating information further comprises the step of maintaining at least one of a Contact Name, a Title, a Company Name, a Company Address including a City Name, a State, and a Zip Code, a Phone Number, a Fax Number, an E-Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business, Notes, Action Items, Products, Database Sub-Sections, Deal History, Contact Information, various Management reports, and other relevant information about the Deal.

27. The method according to claim 20 wherein the client system and the server system are connected via a network and wherein the network is one of a wide area network, a local area network, an intranet and the Internet.

28. A web-based system for managing and tracking sales leads, said system comprising:
a client system comprising a browser;
a data storage device for storing lead information;
a server system configured to be coupled to said client system and said database, said server system further configured to:
receive deal information into a centralized database;
store the deal information into various sub-sections of the centralized database and cross-reference the deal information against an unique identifier for easy retrieval and update; and
retrieve the deal information from the centralized database in response to an inquiry to provide a current status of the deal.

29. A system according to claim 28 wherein said client system is further configured with:
a displaying component for displaying at least one of a first user interface, a second user interface, a third user interface, a fourth user interface, a fifth user interface, a sixth user interface, a seventh user interface, an user interface depicting sales tracker organization set up screen, an user interface prompting the user to supply information on level 2 and level 3 territories, a user interface for providing detail information about every user, a user interface detailing the organization structure as entered by the user, a user interface displaying a thank you message once the enrollment is complete;
a displaying component for displaying at least one of a home page user interface, a View Database user interface, an Add New Contact user interface, a View Product table user interface, a View Notes user interface, an Add Notes user interface, a View Action Items user interface, an Add Action Items user interface, a View Products user interface, an Add Products user interface, a View Deal Status user interface, an Add New Contact user interface, an Action Items user interface, a Reporting user interface, an Add/Update Users user interface, a Change Company Profile user interface, a Change Payment Information user interface, a Change Organization user interface, an Add Territory user interface, a Move Territory user interface, a Rename Territory user interface, a Delete Territory user interface, a Change Administrator user interface, an Add/Update Product Table user interface; and
a sending component to send an inquiry to the server system so that the server system can process and download the requested information to the client system.

30. A system according to claim 29 wherein the sending component functions in response to a click of a mouse button.

31. A system according to claim 29 wherein the sending component functions in response to a voice command.

32. A system according to claim 29 wherein said system is further configured to be protected from access by unauthorized individuals.

33. A system according to claim 28 wherein said server system is further configured with:
a collection component for collecting information from users into the centralized database;
a tracking component for tracking information on an on-going basis;
a displaying component for displaying at least one of a first user interface, a second user interface, a third user interface, a fourth user interface, a fifth user interface, a sixth user interface, a seventh user interface, an user interface depicting sales tracker organization set up screen, an user interface prompting the user to supply information on level 2 and level 3 territories, a user interface for providing detail information about every user, a user interface detailing the organization structure as entered by the user, a user interface displaying a thank you message once the enrollment is complete informing the user that the enrollment is complete, a home page user interface, a View Database user interface, an Add New Contact user interface, a View Product table user interface, a View Notes user interface, an Add Notes user interface, a View Action Items user interface, an Add Action Items user interface, a View Products user interface, an Add Products user interface, a View Deal Status user interface, an Add New Contact user interface, an Action Items user interface, a Reporting user interface, an Add/Update Users user interface, a Change Company Profile user interface, a Change Payment Information user interface, a Change Organization user interface, an Add Territory user interface, a Move Territory user interface, a Rename Territory user interface, a Delete Territory user interface, a Change Administrator user interface, an Add/Update Product Table user interface;
a receiving component for receiving an inquiry from the client system regarding at least one of a first user interface, a second user interface, a third user interface, a fourth user interface, a fifth user interface, a sixth user interface, a seventh user interface, an user interface depicting sales tracker organization set up screen, an user interface prompting the user to supply information on level 2 and level 3 territories, a user interface for providing detail information about every user, a user interface detailing the organization structure as entered by the user, a user interface displaying a thank you message once the enrollment is complete informing the user that the enrollment is complete and that the user may now use the system to track sales leads, a home page user interface, a View Database user interface, an Add New Contact user interface, a View Product table user interface, a View Notes user interface, an Add Notes user interface, a View Action Items user interface, an Add Action Items user interface, a View Products user interface, an Add Products user interface, a View Deal Status user interface, an Add New Contact user interface, an Action Items user interface, a Reporting user interface, an Add/Update Users user interface, a Change Company Profile user interface, a Change Payment Information user interface, a Change Organization user interface, an Add Territory user interface, a Move Territory user interface, a Rename Territory user interface, a Delete Territory user interface, a Change Administrator user interface, an Add/Update Product Table user interface; and
an accessing component for accessing the centralized database and causing the retrieved information to be displayed on the client system.

34. A system according to claim 33 wherein said server system further configured with a receiving component for receiving an inquiry to provide information from one of a plurality of users.

35. A system according to claim 33 wherein said server system further configured with a processing component for searching and processing received inquiries against the data storage device containing a variety of information collected by the collection component.

36. A system according to claim 33 wherein said server system further configured with a retrieving component to retrieve information from the data storage device.

37. A system according to claim 33 wherein said server system further configured with an information fulfillment component that downloads the requested information after retrieving from the data storage device to the plurality of users in the order in which the requests were received by the receiving component.

38. A system according to claim 28 wherein said server system further configured to:
receive at least one of a Contact Name, a Title, a Company Name, a Company Address including a City Name, a State, and a Zip Code, a Phone Number, a Fax Number, an E-Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business, Notes, Action Items, Products, Database Sub-Sections, Deal History, Contact Information, various Management reports, and other relevant information about the Deal;
update at least one of a Contact Name, a Title, a Company Name, a Company Address including a City Name, a State, and a Zip Code, a Phone Number, a Fax Number, an E-Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business, Notes, Action Items, Products, Database Sub-Sections, Deal History, Contact Information, various Management reports, and other relevant information about the Deal; and
store at least one of a Contact Name, a Title, a Company Name, a Company Address including a City Name, a State, and a Zip Code, a Phone Number, a Fax Number, an E-Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business, Notes, Action Items, Products, Database Sub-Sections, Deal History, Contact Information, various Management reports, and other relevant information about the Deal.

39. A system according to claim 28 wherein said server system further configured to enter information at least through one of a voice activation command and a device connected to the client system.

40. A system according to claim 28 wherein said server system further configured to store the deal information against an identifier.

41. A system according to claim 28 wherein said server system further configured to:
track the deal information on a real time basis; and
store the deal information on a real time basis by updating stored information by adding the new information to the centralized database on a real time basis to provide up-to-date deal information instantaneously to the user upon a request.

42. A system according to claim 28 wherein said server system further configured to:
download requested information from a server system; and
display requested information on a client system in response to the inquiry.

43. A system according to claim 42 wherein said server system further configured to print the requested information in a pre-determined format.

44. A system according to claim 28 wherein said server system further configured to accept an inquiry from a user.

45. A system according to claim 44 wherein said server system further configured to:
receiving an inquiry from the client system; and
display information on the client system.

46. A system according to claim 45 wherein said server system further configured to submit a request through at least one of pull down menus, check boxes, and hypertext links.

47. A system according to claim 45 wherein said server system further configured to display an HTML document downloaded by the server system.

48. A system according to claim 45 wherein said server system further configured to display at least one alternative from various alternatives available to the user.

49. A system according to claim 42 wherein said server system further configured to:
access the centralized database;
search the database regarding the specific inquiry;
retrieve information from the database; and
transmit the retrieved information to the client system for display by the client system.

50. A system according to claim 42 wherein said server system further configured to extract sales deals tracking data into at least one of a database software and a financial spread sheet software.

51. A system according to claim 28 wherein said server system further configured to receive data extracts from at least one of a database software and a financial spread sheet software.

52. A computer program embodied on a computer readable medium for managing deals, comprising:
a code segment that sets up the user's organizational hierarchy through enrollment process and then:
maintains a database by adding, deleting and updating information;
tracks action items according to assigned priorities;
generates management reports; and
provides flexibility to an administrator to modify user profile information.

53. The computer program as recited in claim 52 further includes a code segment that provides online help to the user by downloading a user manual on to a client device.

54. The computer program as recited in claim 52 that sets up the user's organizational hierarchy through enrollment process further includes:
a code segment that provides information about a user, the user's company, number of users planning to utilize the method, a name of an administrator and other related information, and payment information including a credit card number, billing address, credit card type, credit card expiration date; and
a code segment that provides information about the user's sales organization including sales territories, information about each sales representative and associated sales territory each sales representative is assigned to, and reporting relationship among sales territories.

55. The computer program as recited in claim 52 that sets up the user's organizational hierarchy through enrollment process further includes a code segment that:
adds another territory;
renames a territory;
adds another user; and
updates a user.

56. The computer program as recited in claim 52 further includes a code segment that generates at least one of Descriptions Report, Contacts Report, Action Items Report, Activities Report, Sales Funnel Report, Sales Forecast Report, Won and Lost Deals Report, and Products Report.

57. The computer program as recited in claim 52 further includes a code segment that provides an option to the administrator which includes at least one of changing company profile option, changing payment information option, changing organization structure option, updating users option, changing administrator option, and updating product table option.

58. The computer program as recited in claim 52 further includes a code segment that maintains at least one of a Contact Name, a Title, a Company Name, a Company Address including a City Name, a State, and a Zip Code, a Phone Number, a Fax Number, an E-Mail address, Deal Status, Deal Amount that can be realized if the deal is closed, Probability of Sale, Expected Close Date, Open Action Items, a Promotion Code, a Contact Source, a Line of Business, a number of Employees and Sales Volume of the business, Notes, Action Items, Products, Database Sub-Sections, Deal History, Contact Information, various Management reports, and other relevant information about the Deal.

59. A computer program embodied on a computer readable medium for managing deals, comprising:
a code segment that receives deal information;
a code segment that enters the deal information into a centralized database;
a code segment that stores the deal information into the centralized database and cross-reference the deal information against an unique identifier; and
a code segment that provides the deal information in response to an inquiry.

60. The computer program as recited in claim 59 further includes a code segment that assigns deals for the entire department by a manager having a supervisory authority over the department.

61. The computer program as recited in claim 60 wherein the network is a wide area network operable using a protocol including at least one of TCP/IP and IPX.

62. The computer program as recited in claim 60 wherein the data is received from the user via a graphical user interface.

63. The computer program as recited in claim 60 further includes a code segment that assigns deals for an employee based on employee job classification.

64. The computer program as recited in claim 60 further includes a code segment that assigns deals by a manager having a supervisory authority to access employee's current work folders maintained in the centralized database.

65. The computer program as recited in claim 60 further includes a code segment that monitors work load and manages performance of sales personnel.

66. The computer program as recited in claim 60 includes a code segment that displays information through an HTML document downloaded by the server system.

67. The computer program as recited in claim 60 further comprising:
a code segment that accesses the centralized database;
a code segment that searches the database regarding the specific inquiry;
a code segment that retrieves information from the database; and
a code segment that causes the retrieved information to be displayed on the client system.

68. The computer program as recited in claim 60 wherein the client system and the server system are connected via a network and wherein the network is one of a wide area network, a local area network, an intranet and the Internet.

69. The computer program as recited in claim 60, and further comprising a code segment that monitors the security of the system by restricting access to unauthorized individuals.
